(19) United States
(12) Patent Application Publication
(10) Pub. No.: US 2007/0104961 A1
(43) Pub. Date: May 10, 2007

(54) Thermoplastic resin sheets provided with functionality by transfer method and their production processes

(76) Inventors: Toshio Awaji, Kawanishi-shi (JP); Naofumi Tsujino, Yao-shi (JP); Kazuhisa Hirata, Suita-shi (JP); Takehisa Kishimoto, Sanda-shi (JP); Akira Ueda, Sanda-shi (JP); Junichiro Nakagawa, Sanda-shi (JP); Michio Matsuura, Sanda-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/591,577

(22) Filed: Nov. 2, 2006

(30) Foreign Application Priority Data
Nov. 2, 2005 (JP) 2005-320210(PAT.)
May 11, 2006 (JP) 2006-132920(PAT.)
Oct. 6, 2006 (JP) 2006-275037(PAT.)

(51) Int. Cl. B32B 27/40

(52) U.S. Cl. 428/423.1

(57) ABSTRACT

The present invention provides a functional thermoplastic resin sheet including a thin film of at least one layer formed on at least one side of a thermoplastic resin sheet by a transfer method, wherein at least one layer of the thin film has functionality. The functional thermoplastic resin sheet of the first invention has a thin film of at least one layer formed on an uneven surface of a thermoplastic resin sheet having the uneven surface by a transfer method. The production process includes transferring, using a transfer film with a thin film of at least one layer formed on a surface of a base film, the thin film to an uneven surface of a thermoplastic resin sheet having the uneven surface, at which when the glass transition temperature of a thermoplastic resin sheet is denoted as Tg, a surface temperature of the thermoplastic resin sheet is in a range of not lower than (Tg−10° C.) and not higher than (Tg+70° C.), and a base film having a softening point lower than the surface temperature of the thermoplastic resin sheet is used. The transfer film uses a specific film as the base film. The light diffusion plate of the second invention is a light diffusion plate for liquid crystal displays, which has a thin film of at least one layer formed on at least one side of a thermoplastic resin sheet by a transfer method, wherein at least one layer of the thin film contains an antistatic agent. The production process includes extruding a thermoplastic resin sheet while transferring a thin film of at least one layer on at least one side of the thermoplastic resin sheet so that at least one layer of the thin film contains an antistatic agent.

### BACKGROUND OF THE INVENTION

The present application claims the benefit of priorities from Japanese Patent Application No. 2005-320210, filed on Nov. 2, 2005, Japanese Patent Application No. 2006-132920, filed on May 11, 2006, and Japanese Patent Application No. 2006-275037, filed on Oct. 6, 2006, all the contents of which are incorporated herein by reference.

### FIELD OF THE INVENTION

The present invention relates to thermoplastic resin sheets provided with functionality by a transfer method and their production processes. Specifically, the present invention relates to, as a first invention, a functional thermoplastic resin sheet having an even surface and its production process, as well as a transfer film, and relates to, as a second invention, a light diffusion plate for liquid crystal display devices and its production process.

### DESCRIPTION OF THE RELATED ART

As a process for providing a thermoplastic resin sheet with functionality, there is a well known process in which when a thermoplastic resin sheet is extruded, using a transfer film with a thin film having various kinds of functionalities formed on the surface of a base film, the thin film is transferred on the surface of the extruded sheet by a transfer method. For example, Japanese Patent Laid-open Publication No. Hei 5-162230 (1993) discloses a production process of synthetic resin decorative sheet in which a thin film having an antistatic property is formed on a thermoplastic resin sheet by a transfer method. Also, Japanese Patent Laid-open Publications Nos. 2004-90281, 2005-193471, and 2005-193514 disclose production processes of an extruded composite sheet in which a thin film having a surface protection property, a surface anti-reflection property, or an antistatic property is formed on the surface of a thermostatic resin sheet by a transfer method. In these processes, since the surface of an extruded sheet is flat, it is easy to form a thin film with functionality on the surface of the sheet by a transfer method.

However, in the case where the surface of an extruded sheet has an embossed pattern or a mat pattern, or has an optical design such as lenticular lenses or prisms, that is, in the case where the surface of an extruded sheet has an uneven surface, when a thin film with various functionalities is formed on the surface of the sheet by a transfer method, the transfer film cannot follow the uneven surface; therefore, the transfer film comes in point contact with convex portions of the sheet, air enters into concave portions, which lowers the adhesion of the thin film to the sheet, resulting in a problem that the sheet cannot be provided with sufficient functionality.

Additionally, Japanese Patent Laid-open Publication No. Hei 5-162230 (1993) discloses a technique that in the case of pressure bonding a transfer film, an uneven pattern is formed by pressing an emboss roll or an emboss plate on the synthetic resin layer which has been transferred; however, there has been not known a process that a thin film is transferred onto a thermoplastic resin sheet with an uneven surface.

On another front, nowadays, liquid crystal display devices have been utilized in wide applications including cellular phones, PDA terminals, digital cameras, television sets, displays of personal computers, and laptop computers. In a small size liquid crystal display device, a side type backlight unit is disposed behind a liquid crystal display panel to decrease the thickness of the device. In a large size liquid crystal display device used in liquid crystal television sets exceeding 15 inches and liquid crystal displays of desktop personal computers, a direct type backlight unit is disposed behind a liquid crystal display panel to supply light from this backlight unit to the liquid crystal display panel for displaying screen images. Regarding a direct type backlight unit used in a large size liquid crystal display panel, for screen images to be easily viewable, it is required to supply not only uniform light, but also as much light as possible, to the liquid crystal display panel. That is, a direct type backlight unit is required to have optical characteristics with both excellent uniformity of light and high brightness.

A direct type backlight unit is equipped with a lot of members in a housing, for example: in addition to a light source, a reflection sheet for reflecting an outgoing light backward from the light source to a front direction; a light diffusion plate for diffusing light from a light source (i.e., a line light source) into a plane light source and also for erasing the shape of the light source; a light diffusion plate for further diffusing light passed through the light diffusion plate, erasing the shape of the light source, and also collecting light into a front direction to improve brightness; and a prism sheet for collecting light passed through the light diffusion plate into a front direction to improve brightness.

The direct type backlight unit having such a constitution has a problem that, when dust intrudes into the inside, it adheres to the front face of a reflection sheet and the rear face of a light diffusion plate, lowering the uniformity and brightness of outgoing light from the light diffusion plate. In order to solve such a problem, for example, gaps of a housing of the direct type backlight unit have been filled with a sealing tape or the like.

However, when a housing is tightly sealed with a sealing tape or the like, it becomes difficult to disperse the heat of a light source, and the ambient temperature inside the housing becomes high. As a result, there arises another problem that it departs from a suitable temperature for use of the light source (about 40° C.) to deteriorate emission efficiency of the light source and lower brightness.

Thus, it has been desired to develop a technique that suppress an increase in the ambient temperature inside the housing of a direct type backlight unit and also a reduction in the uniformity and brightness of light due to dust intrusion.

Therefore, for example, there have been proposed a method that a vent connecting inside with outside is formed in the upper part of an inside housing accommodating a light source, and a seal member for shielding outside air is equipped in the lower part of the inside housing (see, e.g., Japanese Patent Laid-open Publication No. Hei 6-273765 (1994)); and a method that an open space is set up for supplying cool air from outside downwards to an inside housing (i.e., a closed space) where a light source is accommodated (see, e.g., Japanese Patent Laid-open Publication No. Hei 10-106342 (1998)).

However, these methods have a problem that when a light source is on for a long time, the ambient temperature inside a housing in which a light source is accommodated becomes high, which tends to result in a reduction in the uniformity and brightness of light.

Also, there has been proposed a method that a film with a photocatalyst is attached on a light diffusion plate (see, e.g., Japanese Patent Laid-open Publication No. 2005-108769).

However, since inorganic compounds forming a photocatalyst are difficult to transmit light, there is a problem that the loss of light becomes large and brightness is lowered. Further, there is another problem that light energy generated from a light source in a direct backlight unit cannot sufficiently prevent the adhesion and decomposition of stains.

### SUMMARY OF THE INVENTION

Under the circumstances described above, an object to be attained by the present invention is to provide a thermoplastic resin sheet provided with functionality by a transfer method, particularly to provide a functional thermoplastic resin sheet having an uneven surface, in which a thin film with functionality follows the uneven surface and is formed with high adhesion to the uneven surface of the thermoplastic resin sheet having an uneven surface, its production process, and a transfer film, and also to provide a light diffusion plate for liquid crystal display devices and its production process, in which the adhesion of dust to a light diffusion plate is suppressed, and as a result, a reduction in the uniformity and brightness of light can be prevented, display images can be stabilized for a long period of time, and also the display quality can be improved.

The present inventors have found the following facts as a result of their various studies and completed the present invention, in particular: using a transfer film with a thin film having functionality formed on the surface of a base film, in transferring the thin film to the uneven surface of a thermoplastic resin sheet having an uneven surface, the thin film can be formed with high adhesion thereto while being allowed to follow the uneven surface by adjusting the surface temperature of the thermoplastic resin sheet in a specific range of temperature and using a base film having a specific softening point, and also, dust adhesion can be suppressed conveniently and effectively by providing a thin film containing an antistatic agent on the surface of a light diffusion plate.

Thus, the present invention provides a functional thermoplastic resin sheet having a thin film of at least one layer formed on at least one side of a thermoplastic resin sheet by a transfer method, wherein at least one layer of the thin film has functionality.

In particular, the present invention provides, as the first invention, a functional thermoplastic resin sheet having an uneven surface and its production process, as well as a transfer film, and provides, as the second invention, a light diffusion plate for liquid crystal display devices and its production process.

The first invention provides a functional thermoplastic resin sheet having a thin film of at least one layer formed on the uneven surface of a thermoplastic resin sheet having the uneven surface by a transfer method. A thermoplastic resin forming the sheet may preferably be selected from the group consisting of amorphous resins such as polycarbonate type resins, (meth)acrylic type resins, styrene type resins, (meth)acrylic-styrene copolymers, and cycloolefin type resins. A resin forming at least one layer of the thin film can have, for example, an ultraviolet absorbing property. At least one layer of the thin film can contain, for example, an ultraviolet absorbing agent(s), an antistatic agent(s), a fluorescence whitener(s), and/or fine particles.

The first invention also provides a light diffusion plate for liquid crystal display devices, wherein the functional thermoplastic resin sheet is used for a backlight unit in a liquid crystal display device.

Further, the first invention provides a process for producing the functional thermoplastic resin sheet. The production process comprises transferring, using a transfer film with a thin film of at least one layer formed on a surface of a base film, the thin film to an uneven surface of a thermoplastic resin sheet having the uneven surface, at which when the glass transition temperature of a thermoplastic resin sheet is denoted as Tg, a surface temperature of the thermoplastic resin sheet is in a range of not lower than (Tg−10° C.) and not higher than (Tg+70° C.), and a base film having a softening point lower than the surface temperature of the thermoplastic resin sheet is used.

Further, the first invention provides a transfer film with excellent transferability to an uneven surface for use in the production process. This transfer film has a thin film formed on a surface of a base film, in which at least one kind of film selected from low density polyethylene films, high density polyethylene films, linear low density polyethylene films, biaxially oriented polypropylene films (OPP films), and cast polypropylene films (CPP films) is used as the base film.

According to the first invention, a thin film with functionality can be formed with high adhesion to an uneven surface of a thermoplastic resin sheet having the uneven surface while being allowed to follow the uneven surface. Therefore, for example, even when the surface of a thermoplastic resin sheet has an embossed pattern or a mat pattern, or has an optical design such as lenticular lenses or prisms, such a thermoplastic resin sheet can be provided with various kinds of functionality, such as an antistatic property, a light resistance, a super water repellency, a super hydrophilicity, a defogging property, a low reflection property, and an anti-reflection property.

The second invention provides a light diffusion plate for liquid crystal display devices, which has a thin film of at least one layer formed on at least one side of a thermoplastic resin sheet by a transfer method, wherein at least one layer of the thin film contains an antistatic agent. A thermoplastic resin forming the sheet may preferably be selected from the group consisting of polycarbonate type resins, (meth)acrylic type resins, styrene type resins, and (meth)acrylic-styrene copolymers. A resin forming at least one layer of the thin layer can have, for example, an ultraviolet absorption property. At least one layer of the thin layer can contain, for example, an ultraviolet absorbing agent(s), an antistatic agent(s) a fluorescence whitener(s), and fine particles. Regarding the thin film, there is a case where a layer containing an antistatic agent and a layer containing an ultraviolet absorbing agent are stacked. In the light diffusion plate, a decreasing rate of brightness after an accelerated test of a light resistance may preferably be not higher than 20%, and a surface resistivity after an accelerated test of a light resistance may preferably be not higher than 10¹⁴ Ω.

The second invention also provides a process for producing the light diffusion plate. This production process comprises extruding a thermoplastic resin sheet while transferring a thin film of at least one layer on at least one side of the thermoplastic resin sheet so that at least one layer of the thin film contains an antistatic agent. The transfer may preferably be carried out using a transfer film with the thin film formed on a surface of a base film. The heat resistant temperature of the base film may preferably be 80° C. or higher. The thickness of the base film may preferably be not smaller than 10 μm and not greater than 100 μm. The peel strength of the base film after the thin film was transferred may preferably be not smaller than 0.02 N/cm and not greater than 1.0 N/cm.

According to the second invention, since a light diffusion plate has a thin film containing an antistatic agent(s), the adhesion of dust which intruded inside a housing of a direct type back light unit can be prevented. Therefore, the uniformity and brightness of light can be maintained for a long period of time, so that the image display of liquid crystal display devices can be stabilized for a long period of time and the display quality can be improved, which can contribute to energy saving associated therewith. Also, since a thin film containing an antistatic agent(s) is formed by a transfer method, a light diffusion plate for liquid crystal display devices can efficiently be produced, which is industrially advantageous.

### BRIEF DESCRIPTION OF THE DRAWING

FIG. 1 is a schematic view showing the construction of a typical sheet extruder for use in a production process of the first invention.

### DETAILED DESCRIPTION OF THE INVENTION

### Functional Thermoplastic Resin Sheet

The functional thermoplastic resin sheet of the present invention is a functional thermoplastic resin sheet having a thin film of at least one layer formed on at least one side of a thermoplastic resin sheet by a transfer method, wherein at least one layer of the thin film has functionality. The term “functionality” as used herein means an ultraviolet absorbing property, an antistatic property, a light diffusion property, a light collection property, and the like. These kinds of functionality can be provided by using a resin having an ultraviolet absorbing property as a resin forming at least one layer of the thin film, or by incorporating, for example, an ultraviolet absorbing agent(s), an antistatic agent(s), a fluorescent whitener(s), and fine particles into at least one layer of the thin film.

First, as the first invention, a functional thermoplastic resin sheet having an uneven surface and its production process, as well as a transfer film will be described.

### Functional Thermoplastic Resin Sheet having Uneven Surface

The functional thermoplastic resin sheet having an uneven surface of the first invention (hereinafter referred to sometimes as “the functional thermoplastic resin sheet of the first invention”) comprises a thin film of at least one layer formed by a transfer method on an uneven surface of a thermoplastic resin sheet having the uneven surface. The term “uneven surface” as used herein means that either the front face or the rear face of a thermoplastic resin sheet, or both, are not flat, but have a three-dimensional shape intentionally formed. As the uneven surface, although it is not particularly limited, there can be mentioned, for example, embossed patterns and mat (figured glass) patterns, and optical designs such as lenticular lenses and prisms. Also, the term “a thin film of at least one layer” as used herein means the inclusion of cases in which the thin film is formed by a single layer and cases in which the thin film is formed by two or more layers.

In the case where an uneven surface has an embossed pattern or a mat (figured glass) pattern, the degree of uneven surface is expressed by a center line average roughness as defined in JIS B0601:2001 Appendix 2. In this case, a cutoff value in obtaining a center line average roughness is set to be 0.8 mm, and an evaluation length is set to be 4 mm. Additionally, a center line average roughness can be determined, for example, by a surface roughness tester. In this case, the center line average roughness of an uneven surface may preferably be in a range of from 0.5 to 15 μm, more preferably from 1 to 10 μm. When the center line average roughness of an uneven surface is smaller than 0.5 μm, there are cases of lack of design. In contrast, when the center line average roughness of an uneven surface is greater than 15 μm, it may be difficult to transfer a thin film into the deepest parts of concave portions.

In the case where an uneven surface has an optical design such as lenticular lenses or prisms, the degree of uneven surface is expressed by a pitch and a depth of the same shape in the optical design. For example, in the case where an uneven surface has a lenticular lens or prism shape, the pitch may preferably be in a range of from 30 to 500 μm, more preferably from 50 to 300 μm, and the depth may preferably be in a range of from 10 to 300 μm, more preferably from 20 to 200 μm. Additionally, the pitch and depth in the same shape can be measured, for example, by a non-touch step tester or a laser confocal microscope. In particular, when a light diffusion plate is produced by transferring a functional thin film to a thermoplastic resin sheet having an optical design, required optical performance cannot be obtained in some cases, if the pith is outside the above range. Also, if the depth is smaller than 10 μm, required optical performance cannot be obtained in some cases. In contrast, if the depth is greater than 300 μm, it may be difficult to transfer a thin film to the deepest parts of concave portions. Additionally, the shape of lenticular lens may be either concave or convex, or a combination thereof.

The functional thermoplastic resin sheet of the first invention has any kind of functionality, for example, an antistatic property, a light resistance, a super water repellency, a super hydrophilicity, a defogging property, a low reflection property, and an anti-reflection property. These kinds of functionality are basically derived from a thin film transferred on an uneven surface. That is, any of additives exhibiting these kinds of functionality may be incorporated into a thin film to be transferred to an uneven surface, or a thin film may be formed of any of thermoplastic resins having these kinds of functionality.

<Thermoplastic Resin Sheet>

As a material of the thermoplastic resin sheet, although it is not particularly limited, there can be used all thermoplastic resins capable of being processed into a plate having an uneven surface. In particular, amorphous resins are preferred, such as polycarbonate type resins including polycarbonate (PC); (meth)acrylic type resins including poly(methyl methacrylate) (PMMA); styrene type resins including polystyrene (PS); (meth)acrylic-styrene copolymers including polymethacrylstyrene (MS); and cycloolefin type resins including cycloolefin polymers (COPs) and cycloolefin copolymers (COCs). The thermoplastic resin sheet may be made of a single material or of two or more kinds of materials, and also, may be formed by a single layer or by two or more layers.

Additionally, the term “amorphous resin(s)” as used herein means a thermoplastic resin(s) having no clear melting point as a resin in the DSC measurement according to a DSC measurement method (a thermal flow rate DSC) as defined in JIS K7121.

Additives may be added to a thermoplastic resin sheet, such as stabilizers, antioxidants, plasticizers, dispersants, and fluorescent whiteners. The amount of each of these additives to be added may appropriately be adjusted depending upon their kinds and the like, although it is not particularly limited.

The thickness of a thermoplastic resin sheet may preferably be not smaller than 0.5 mm and not greater than 5 mm, more preferably not smaller than 0.8 mm and not greater than 3 mm. When the thickness of a thermoplastic resin sheet is smaller than 0.5 mm, it may have lowered mechanical strength. In contrast, when the thickness of a thermoplastic resin sheet is greater than 5 mm, for example, in the case of use as a light diffusion plate for liquid crystal display devices, the amount of light passing through the sheet may be reduced, resulting in a lowered brightness.

The thermoplastic resin sheet can contain fine particles to diffuse light from a light source uniformly and excellently, for example, in the case of use as a light diffusion plate for liquid crystal display devices. It is preferred that the fine particles contained in a thermoplastic resin sheet are substantially uniformly dispersed. Also, when a thermoplastic resin sheet is formed by two or more layers, the fine particles contained in the thermoplastic resin sheet may be contained in any of these layers.

As a material of the fine particles, there can be mentioned, for example, synthetic resins such as (meth)acrylic type resins, styrene type resins, polyurethane type resins, polyester type resins, silicone type resins, fluorocarbon type resins, and copolymers thereof; glass; clay compounds such as smectite and kaolinite; and inorganic oxides such as silica and alumina. In these materials, (meth)acrylic type resins, styrene type resins, silicone type resins, and silica may particularly be preferred.

The average particle diameter of fine particles may preferably be not smaller than 0.1 μm and not greater than 30 μm, more preferably not smaller than 0.5 μm and not greater than 25 μm, and still more preferably not smaller than 1 μm and not greater than 20 μm. When the average particle diameter of fine particles is smaller than 0.1 μm, light incident to a thin film cannot sufficiently be diffused in some cases. In contrast, when the average particle diameter of fine particles is greater than 30 μm, the amount of light passing through a thin film may be reduced, resulting in a lowered brightness. Additionally, the average particle diameter of fine particles is a simply averaged value of particle diameters for which arbitrary hundred fine particles are measured with a microscope. Also, in the case of each fine particle with an irregular shape, an average of the maximum diameter and the minimum diameter is defined as the average diameter.

Since the shape of fine particles is the same as that of the fine particles to be contained in a thin film which will be explained below, their explanation is omitted here. However, the amount of fine particles to be used may preferably be not lower than 0.1 parts by weight and not higher than 20 parts by weight, more preferably not lower than 0.2 parts by weight and not higher than 10 parts by weight, relative to 100 parts by weight of a thermoplastic resin forming a sheet. When the amount of fine particles to be used is lower than 0.1 parts by weight, light incident to a thin film cannot sufficiently be diffused in some cases. In contrast, when the amount of fine particles to be used is higher than 20 parts by weight, the extrusion of a sheet may become difficult, or the amount of light passing through a thin film may be reduced, resulting in a lowered brightness.

<Thin Film>

In the functional thermoplastic resin sheet of the first invention, a thin film is formed on one side or both sides of a thermoplastic resin sheet. The thin film may be made of a single material or of two or more kinds of materials, and also, may be formed by a single layer or by two or more layers. The thickness of a thin film (or the thickness of each layer in the case of a thin film formed by two or more layers) may preferably be not smaller than 0.01 μm and not grater than 30 μm, more preferably not smaller than 0. 05 μm and not greater than 20 μm, and still more preferably not smaller than 0.1 μm and not greater than 10 μm. When the thickness of a thin film is smaller than 0.01 μm, the effect of exhibiting various kinds of functionality may be small, and the formation of a uniform thin film may become difficult. In contrast, when the thickness of a thin film is greater than 30 μm, warping may occur due to a difference in the thermal shrinkage ratio or a difference in the water absorption in the case where a material different from the thermoplastic resin sheet is used. Additionally, the thickness of a thin film is a value measured by the method described in Examples.

As a material forming a thin film, although it is not particularly limited, there can be mentioned, for example, (meth)acrylic type resins, saturated polyester type resins, epoxy type resins, and silicone type resins. These resins may be used alone, or two or more kinds of these resins may also be used in combination. In these resins, (meth)acrylic type resins may be preferred from the viewpoint that various kinds of functionality can easily be provided.

It is possible to harden using various means after transfer by adding a functional group(s) and a sensitizer(s) to a resin and its composition, each of which constitutes a thin film. The functional group(s) and the sensitizer(s) are not particularly limited, specific examples of which are a hydroxyl group(s) and a multi-functional isocyanate(s) including a blocked isocyanate(s); a vinyl group(s) and a peroxide compound(s); a hydroxyl group(s) and a multi-functional acid anhydride(s); a carboxylic acid(s) and a multi-functional epoxy group(s); a hydroxyl group(s) and an epoxy group(s); and a carboxylic acid(s) and an oxazoline compound(s). These combinations may be selected depending upon a required functionality.

As a monomer forming a (meth)acrylic type resin, there can be mentioned, for example, (meth)acrylic acid esters such as methyl (meth)acrylate, ethyl (meth)acrylate, butyl (meth)acrylate, cyclohexyl (meth)acrylate, phenyl (meth)acrylate, benzyl (meth)acrylate, 2-ethylhexyl (meth)acrylate, and 2-hydroxyethyl (meth)acrylate. These monomers may be used alone, or two or more kinds of these monomers may also be used in combination.

Also, in addition to the above monomers, to the extent that the gists of the first invention are not deteriorated, there may be copolymerized, for example, with unsaturated acids such as (meth)acrylic acid; styrene, butadiene, isoprene, α-methylstyrene, (meth)acrylonitrile, maleic anhydride, phenylmaleimide, and cyclohexylmaleimide. These monomers may be used alone, or two or more kinds of these monomers may also be used in combination.

The (meth)acrylic type resins may have a crosslink structure. As a crosslinking agent, there can be mentioned, for example, isocyanate compounds including blocked isocyantes; epoxy compounds; aziridine compounds; oxazoline compounds; and multifunctional acid anhydrides. These crosslinking agents may be used alone, or two or more kinds of these crosslinking agents may also be used in combination. In these crosslinking agents, isocyante compounds may particularly be preferred.

In the polymerization of a (meth)acrylic type resin, for example, a monomer having an antistatic property or a monomer having an ultraviolet absorption property can be copolymerized. Additionally, it is preferred to use a monomer having an ultraviolet absorption property described, for example, in Japanese Patent No. 2974943, Japanese Patent Laid-open Publications Nos. 2003-268048 and 2006-89535. Also, if necessary, various additives may be mixed in the polymerization system, including polymerization retardants, chain transfer agents, polymerization accelerators, defoaming agents, leveling agents, mold releasing agents, and surfactants.

As the method of polymerizing the above monomers, any of the heretofore known polymerization methods may be employed, such as bulk polymerization, solution polymerization, emulsification polymerization, suspension polymerization, and dispersion polymerization, although it is not particularly limited. In these polymerization methods, solution polymerization may particularly be preferred, in which a solvent having good solubility to additives such as antistatic agents and ultraviolet absorbing agents is used.

In the functional thermoplastic resin sheet of the first invention, in order for the sheet to exhibit various kinds of functionality, a thin film contains additives exhibiting these kinds of functionality, including antistatic agents, ultraviolet absorbing agents, fluorescent whiteners, and fine particles, or a thin film is composed of a thermoplastic resin exhibiting these kinds of functionality. For example, a thermoplastic sheet can be provided with a light resistance property when at least one layer of a thin film is composed by using, for example, an acrylic resin having an ultraviolet absorption property (e.g., HALS hybrid UV-G series available from Nippon Shokubai Co., Ltd.).

Also, to a thin film, additives may be added, including stabilizers, antioxidants, plasticizers, and dispersers. The amount of each of these additives to be added may appropriately be adjusted depending upon their kinds and the like, although it is not particularly limited.

<Antistatic Agent>

In the functional thermoplastic resin sheet of the first invention, at least one layer of a thin film can contain an antistatic agent(s). The term “at least one layer of a thin film” as used herein means, in the case where a thin film is formed by a single layer, the thin film itself, and in the case where a thin film is formed by two or more layers, at least one layer in two or more layers of this thin film. When an antistatic compound(s) is (are) contained in at least one layer of a thin film, a functional thermoplastic sheet exhibits such a functionality that it can prevent the adhesion of dust existing in air and the malfunction of a device due to static electricity.

As the antistatic agent, any of the heretofore known antistatic agents may be employed, although it is not particularly limited. For example, in the case where a functional thermoplastic resin sheet is used as a light diffusion plate for liquid crystal display devices, inorganic type antistatic agents are not preferred because they may be difficult to transmit light, leading to a lowering of light loss. Therefore, it is preferred to use a surfactant(s) and/or an electrically conductive resin(s) as an organic antistatic agent(s) free from light loss.

As the surfactant which can be used as an antistatic agent, there can be mentioned, for example, anionic surfactants such as olefin type sulfate esters or their metal salts including alkylsulfuric acid, alkylbenzene sulfuric acid, and their Li, Na, Ca, Mg, and Zn salts, and phosphate esters of higher alcohols; cationic surfactants such as tertiary amines, quaternary ammonium salts, cationic acrylate ester derivatives, and cationic vinyl ether derivatives; amphoteric surfactants such as alkylamine type betaine amphoteric salts, amphoteric salts of alanine with carboxylic acids or sulfonic acids, and amphoteric salts of alkylimidazoline; and nonionic surfactants such as esters of fatty acids with polyhydric alcohols and polyoxyethylene adducts of alkylamines. As the electrically conductive resin which can be used as an antistatic agent, there can be mentioned, for example, polyvinylbenzyl type cationic resins and polyacrylic acid type cationic acids. These antistatic agents may be used alone, or two or more kinds of these antistatic agents may also be used in combination. In these antistatic agents, cationic surfactants such as tertiary amines and quaternary ammonium salts may particularly be preferred.

The amount of antistatic agent to be used may preferably be not lower than 0.1 parts by weight and not higher than 100 parts by weight, more preferably not lower than 0.2 parts by weight and not higher than 70 parts by weight, and still more preferably not smaller than 0.3 parts by weight and not greater than 50 parts by weight, relative to 100 parts by weight of a thermoplastic resin(s) forming a thin film containing the antistatic agent(s). When the amount of antistatic agent to be used is smaller than 0.1 parts by weight, the effect of preventing the adhesion of dust or the effect of preventing the malfunction of a device may be small. In contrast, when the amount of antistatic agent to be used is higher than 100 parts by weight, the effect of preventing the adhesion of dust or the effect of preventing the malfunction of a device may be saturated.

As described above, the functional thermoplastic resin sheet of the first invention, in the case where at least one layer of a thin film contains an antistatic agent(s), exhibits the functionality of preventing the adhesion of dust existing in air or preventing the malfunction of a device due to static electricity.. Specifically, the surface resistivity on a thin film side containing an antistatic agent(s) may preferably be not higher than 10¹² Ω, more preferably not higher than 10¹¹ Ω, and still more preferably not higher than 10¹⁰ Ω. When the surface resistivity is higher than 10¹² Ω, the adhesion of dust or the malfunction of a device cannot be prevented in some cases. The term “surface resistivity” as used herein means a value measured in accordance with JIS K6911.

<Ultraviolet Absorbing Agent>

In the functional thermoplastic resin sheet of the first invention, at least one layer of a thin film can contain an ultraviolet absorbing agent(s). The term “at least one layer of a thin film” as used herein means, in the case where a thin film is formed by a single layer, the thin film itself, and in the case where a thin film is formed by two or more layers, at least one layer in two or more layers of this thin film. Additionally, a thin film containing an ultraviolet absorbing agent(s) may preferably be formed on the surface of a functional thermoplastic resin sheet on which side the sheet receives light. This is because preventing the influence of light is intended. When an ultraviolet absorbing agent(s) is (are) contained in at least one layer of a thin film, it has a high light resistance property; therefore, for example, in the case where a functional thermoplastic sheet is used as a light diffusion plate for liquid crystal display devices, display images of liquid crystal display devices can be stabilized for a long period of time and their display quality can be improved.

As the ultraviolet absorbing agent, any of the heretofore known ultraviolet absorbing agents may be used, although it is not particularly limited. For example, there can be mentioned low molecule type ultraviolet absorbing agents such as salicylic acid phenyl ester type ultraviolet absorbing agents, benzophenone type ultraviolet absorbing agents, triazine type ultraviolet absorbing agents, benzotriazole type ultraviolet absorbing agents, cyclic imino ester type ultraviolet absorbing agents, and hybrid type ultraviolet absorbing agents containing both a hindered phenol structure and a hindered amine structure in a molecule; and polymer type ultraviolet absorbing agents in such a form that these low molecule type ultraviolet absorbing agents are pendant to polymers. These ultraviolet absorbing agents may be used alone, or two or more kinds of these ultraviolet absorbing agents may also be used in combination. Also, it is preferred to use a hindered amine type ultraviolet absorbing agent(s).

As the salicylic acid phenyl ester type ultraviolet absorbing agent, there can be mentioned specifically, for example, phenyl salicylate, p-tert-butylphenyl salicylate, and p-octylphenyl salicylate.

As the benzophenone type ultraviolet absorbing agent, there can be mentioned specifically, for example, 2,4-dihydroxybenzophenone, 2-hydroxy-4-methoxy-benzophenone, 2-hydroxy-4-octoxybenzophenone, 2-hydroxy-4-benziloxybenzophenone, 2-hydroxy-4-methoxy-5-sulfoxybenzophenone, 2-hydroxy-4-methoxy-5-sulfoxytrihydrideratebenzophenone, 2,2′-dihydroxy-4-methoxybenzophenone, 2,2′,4,4′-tetrahydroxybenzophenone, 2,2′-dihydroxy-4,4′-dimethoxybenzophenone, 2,2′-dihydroxy-4,4′-dimethoxy-5-sodiumsulfoxy-benzophenone, bis(5-benzoyl-4-hydroxy-2-methoxy-phenyl)methane, 2-hydroxy-4-n-dodecyloxy-benzophenone, and 2-hydroxy-4-methoxy-2′-carboxy-benzophenone.

As the triazine type ultraviolet absorbing agent, there can be mentioned specifically, for example, 2-(4,6-diphenyl-1,3,5-triazin-2-yl)-5-hexyloxy-phenol.

As the benzotriazole type ultraviolet absorbing agent, there can be mentioned specifically, for example, 2-(2-hydroxy-5-methylphenyl)benzotriazole, 2-(2-hydroxy-5-tert-octylphenyl)benzotriazole, 2-(2-hydroxy-3,5-dicumylphenyl) phenylbenzotriazole, 2-(2-hydroxy-3-tert-butyl-5-methylphenyl)-5-chloro-benzotriazole, 2,2′-methylenebis[4-(1,1,3,3-tetra-methylbutyl)-6-(2H-benzotrialzol-2-yl)phenol], 2-(2-hydroxy-3,5-di-tert-butylphenyl)benzotriazole, 2-(2-hydroxy-3,5-di-tert-butylphenyl)-5-chloro-benzotriazole, 2-(2-hydroxy-3,5-di-tert-amyl-phenyl)benzotriazole, 2-(2-hydroxy-5-tert-octyl-phenyl)benzotriazole, 2-(2-hydroxy-5-tert-butyl-phenyl)benzotriazole, 2-(2-hydroxy-4-octoxy-phenyl)benzotriazole, 2,2′-methylene-bis(4-cumyl-6-benzotriazolephenyl), 2,2′-p-phenylenebis(1,3-benzooxazin-4-one), and 2-[2-hydroxyl-3-(3,4,5,6-tetrahydrophthalimide-methyl)-5-methylphenyl]benzotriazole.

As the cyclic imino ester type ultraviolet absorbing agent, there can be mentioned specifically, for example, 2,2′-p-phenylenebis(3,1-benzo-oxazin-4-one), 2,2′-(4,4′-diphenylene)-bis(3,1-benzooxazin-4-one), and 2,2′-(2,6-naphthalene)bis(3,1-benzooxazin-4-one).

As the hybrid type ultraviolet absorbing agent containing both the hindered phenol structure and the hindered amine structure in a molecule, there can be mentioned specifically, for example, 2-(3,5-di-tert-butyl-4-hydroxybenzyl)-2-n-butyl-malonic acid bis(1,2,2,6,6-pentamethyl-4-piperidyl), and 1-[2-[3-(3,5-di-tert-butyl-4-hydroxyphenyl)-propionyloxy]ethyl]-4-[3-(3,5-di-tert-butyl-4-hydroxyphenyl)propionyloxy]-2,2,6,6-tetramethyl-piperidine.

As the polymer type ultraviolet absorbing agents in such a form that low molecule ultraviolet absorbing agents are pendant to polymers, there can be mentioned, for example, polymer type ultraviolet absorbing agents described in Japanese Patent No. 2974943, Japanese Patent Laid-open Publications Nos. 2003-268048 and 2006-89535, and there can be mentioned specifically, for example, HALS hybrid UV-G series available from Nippon Shokubai Co., Ltd.

In these ultraviolet absorbing agents, there may particularly be preferred 2-hydroxy-4-n-octoxy-benzophenone, 2-(4,6-diphenyl-1,3,5-triazin-2-yl)-5-hexyloxyphenol, 2-(2-hydrooxy-5-tert-octyl-phenyl)benzotriazole, 2-(2-hydroxy-3,5-dicumyl-pheyl)phenylbenzotriazole, 2-(2-hydroxy-3-tert-butyl-5-methylphenyl)-5-chlorobenzotriazole, 2,2′-methylenebis[4-(1,1,3,3-tetramethylbutyl)-6-(2H-benzotrialzol-2-yl)phenol], 2,2′-p-phenylene-bis(3,1-benzooxazin-4-one), and HALS hybrid UV-G series available from Nippon Shokubai Co., Ltd.

As the hindered amine type ultraviolet absorbing agent, there can be mentioned specifically, for example, bis(2,2,6,6-)tetramethyl-4-piridyl)sebacate and bis(1,2,2,6,6-pentamethyl-4-piridyl)sebacate.

The amount of ultraviolet absorbing agent to be used may preferably be not smaller than 0.5 parts by weight and not greater than 50 parts by weight, more preferably not smaller than 0.8 parts by weight and not greater than 40 parts by weight, and still more preferably not smaller than 1 part by weight and not greater than 30 parts by weight, relative to 100 parts by weight of a thermoplastic resin forming a thin film containing the ultraviolet absorbing agent. When the amount of ultraviolet absorbing agent to be used is smaller than 0.5 parts by weight, the effect of preventing the influence of light may be small. In contrast, when the amount of ultraviolet absorbing agent to be used is greater than 50 parts by weight, the effect of preventing the influence of light may be saturated.

As described above, the functional thermoplastic resin sheet of the first invention, in the case where at least one layer of a thin film contains an ultraviolet absorbing agent(s) exhibits the effect of preventing the influence of light. Specifically, when an ultraviolet ray having an intensity of 100 mW/cm² is irradiated to a thin film side containing an ultraviolet absorbing agent(s) for 50 hours, the ΔYI value calculated by the following formula may preferably be not higher than 5, more preferably not higher than 4.5, and still more preferably not higher than 4.0; formula: ΔYI=Yellow index (YI) after irradiation of ultraviolet ray−Yellow index (YI) before irradiation of ultraviolet ray. Additionally, yellow index (YI) is a value measured in accordance with JIS Z8722.

<Fluorescent Whitener>

In the functional thermoplastic resin sheet of the first invention, at least one layer of a thin film can contain a fluorescent whitener(s). The term “at least one layer of a thin film” means, in the case where a thin film is formed by a single layer, the thin film itself, and in the case where a thin film is formed by two or more layers, at least one layer in two or more layers of this thin film. The fluorescent whitener has the action of absorbing the energy of an ultraviolet ray contained in light and changing this energy into a visible light. Therefore, when a thin film containing an ultraviolet absorbing agent(s) is provided, the loss of light due to the refraction and absorption of light can be compensated to improve the uniformity and brightness of light. These kinds of functionality are particularly useful in the case where a functional thermoplastic sheet is used as a light diffusion plate for liquid crystal display devices.

As the fluorescent whitener, any of the heretofore known fluorescent whiteners may be used, although it is not particularly limited. For example, there can be mentioned oxazole type fluorescent whiteners, cumarin type fluorescent whiteners, stilbene type fluorescent whiteners, imidazole type fluorescent whiteners, triazole type fluorescent whiteners, naphthalimide type fluorescent whiteners, and rhodamine type fluorescent whiteners. These fluorescent whiteners may be used alone, or two or more kinds of these fluorescent whiteners may also be used in combination. In these fluorescent whiteners, oxazole type fluorescent whiteners and cumarin type fluorescent whiteners may particularly be preferred.

The amount of fluorescent whitener to be used may preferably be not smaller than 0.0005 parts by weight and not greater than 50 parts by weight, more preferably not smaller than 0.001 parts by weight and not greater than 30 parts by weight, relative to 100 parts by weight of a resin(s) forming a thin film containing the fluorescent whitener. When the amount of fluorescent whitener to be used is smaller than 0.0005 parts by weight, the effect of improving the uniformity and brightness of light may be small. In contrast, when the amount of fluorescent whitener to be used is greater than 50 parts by weight, the uniformity of light may rather be deteriorated or the mechanical strength of the thin film may be deteriorated, and also, it may result in using an expensive fluorescent whitener(s) more than necessary and increasing production costs.

<Fine Particles>

In the functional thermoplastic resin sheet of the first invention, at least one layer of a thin film can contain fine particles. The term “at least one layer of a thin film” as used herein means, in the case where a thin film is formed by a single layer, the thin film itself, and in the case where a thin film is formed by two or more layers, at least one layer of two or more layers in this thin film. It is preferred that fine particles contained in a thin film are substantially uniformly dispersed. The fine particles diffuse light uniformly and excellently, so that the uniformity and brightness of light can be improved. These kinds of functionality are particularly useful in the case where a functional thermoplastic sheet is used as a light diffusion plate for liquid crystal display devices.

As a material of the fine particles, there can be mentioned, for example, synthetic resins such as (meth)acrylic type resins, styrene type resins, polyurethane type resins, polyester type resins, silicone type resins, fluorocarbon type resins, and their copolymers; glass; clay compounds such as smectite and kaolinite; and inorganic oxides such as silica and alumina. In these materials, (meth)acrylic type resins, styrene type resins, (meth)acrylic-styrene copolymers, silicone type resins and silica may particularly be preferred.

The fine particles may be made of a single material or of two or more kinds of materials, and also, may be formed by one kind of fine particle made of the same material or by two or more kinds of fine particles made of different materials.

The shapes of fine particles may be, for example, spherical, flat, elliptical, polygonal, and platy. The fine particles having these shapes may be used alone, or two or more kinds of fine particles having these shapes may also be used in combination. In the fine particles having these shapes, spherical particles may be preferred, but there are cases where non-spherical particle such as flat, elliptical, polygonal, and platy particles are preferred because of their having a light diffusion property stronger than spherical particles and their being capable of obtaining high brightness with a small amount for addition.

The average particle diameter of fine particles may preferably be not smaller than 0.1 μm and not greater than 30 μm, more preferably not smaller than 0.5 μm and not greater than 25 μm, and still more preferably not smaller than 1 μm and not greater than 20 μm. When the average particle diameter of fine particles is smaller than 0.1 μm, light incident to a thin film cannot sufficiently be diffused in some cases. In contrast, when the average particle diameter of fine particles is greater than 30 μm, the amount of light passing through a thin film may be reduced, resulting in a lowered brightness. Additionally, the average particle diameter of fine particles is a simply averaged value of particle diameters for which arbitrary hundred fine particles are measured with a microscope. Also, in the case of each fine particle with a non-spherical shape, an average of the maximum diameter and the minimum diameter is defined as the average diameter.

The amount of fine particles to be used may preferably be not smaller than 1 part by weight and not greater than 200 parts by weight, more preferably not smaller than 5 parts by weight and not greater than 150 parts by weight, and still more preferably not smaller than 10 parts by weight and not greater than 100 parts by weight, relative 100 parts by weight of the resin containing the fine particles. When the amount of fine particles to be used is smaller than 1 part by weight, light incident to a thin film cannot sufficiently be diffused in some cases. In contrast, when the amount of fine particles to be used is greater than 200 parts by weight, the formation of a thin film may become difficult, or the amount of light passing through a thin film may be reduced, resulting in a lowered brightness.

<Applications of Functional Thermoplastic Resin sheet>

The functional thermoplastic resin sheet of the first invention can be used as a light diffusion plate for liquid crystal display devices, for example, because it exhibits an excellent light diffusion property when a thin film is formed of a thermoplastic resin(s) having an ultraviolet absorption property and an antistatic agent(s), a fluorescent whitener(s), fine particles, and the like are contained in the thin film.

The light diffusion plate for liquid crystal display devices according to the first invention is characterized in that the functional thermoplastic resin sheet is used for a backlight unit in a liquid crystal display device. The light diffusion plate for liquid crystal display devices according to the first invention can be used as a light diffusion plate in any of the heretofore known direct type backlight units or side light type backlight units of liquid crystal display devices, in which display images of the liquid crystal display devices can be stabilized for a long period of time and their display quality can be improved; therefore, it is preferred to be used as a light diffusion plate in a direct type backlight unit for a large size liquid crystal display device used in liquid crystal television sets exceeding 15 inches and desktop personal computers.

### Transfer Film

The transfer film of the first invention is a transfer film with a thin film formed on a surface of a base film, which transfer film uses at least one kind film selected from low density polyethylene films, high density polyethylene films, linear low density polyethylene films, biaxially oriented polypropylene films (OPP films), and cast polypropylene films (CPP films) as the base film.

The transfer film of the first invention has excellent transferability to an uneven surface; therefore, it is preferred to be used in a production process of a functional thermoplastic resin sheet as described below.

<Preparation of Transfer Film>

To transfer a thin film to a functional thermoplastic resin sheet having an uneven surface, first, a resin(s) forming a thin film and a desired additive(s) such as an antistatic agent(s) and an ultraviolet absorbing agent(s) are dissolved or dispersed in an organic solvent to prepare a resin mixture, and then, the resin mixture is applied to the surface of a base film, followed by drying, to prepare a transfer film with a thin film formed on the surface of the base film. Additionally, in the case where a thin film is formed by two or more layers, a step of applying a resin mixture corresponding to each of the layers to the surface of a base film, followed by drying, will repeatedly be carried out.

As the base film, there can be mentioned, for example, low density polyethylene films, high density polyethylene films, linear low density polyethylene films, biaxially oriented polypropylene films (OPP films), and cast polypropylene films (CPP films). In these films, high density polyethylene films and biaxially oriented polypropylene films may particularly be preferred.

Additionally, into the base film, for example, a mold releasing agent(s) of the coating type or a mold releasing agent(s) of the kneading type may be incorporated to the extent that the gists of the first invention are not deteriorated.

As described above, in transferring a thin film to a thermoplastic resin sheet having an uneven surface, it is necessary that when the glass transition temperature of a thermoplastic resin sheet is denoted as Tg, the surface temperature of the thermoplastic resin sheet should be in a range of not lower than (Tg−10° C.) and not higher than (Tg+70° C.), and a base film having a softening point lower than the surface temperature of the thermoplastic resin sheet should be used. Therefore, a base film used for a transfer film may appropriately be selected depending upon the kind of thermoplastic resin forming the sheet.

The thickness of a base film may preferably be not smaller than 5 μm and not greater than 100 μm, more preferably not smaller than 10 μm and not greater than 80 μm, and still more preferably not smaller than 15 μm and not greater than 60 μm. When the thickness of a base film is smaller than 5 μm, the tensile strength of the base film may be insufficient, so that the base film may be broken in pressure bonding. In contrast, when the thickness of a base film is greater than 100 μm, not only the base film may become disadvantageous in costs, but also pressure bonding by rolls may become uneven, so that there may occur the irregularity of a thin film transferred.

As the organic solvent to prepare a resin mixture, it may appropriately be selected depending upon the kind of resin or additive, although it is not particularly limited. For example, there can be mentioned aromatic solvents such as benzene, toluene, xylene, and chlorobenzene; ether solvents such as 1,4-dioxane and tetrahydrofuran; ketone solvents such as methyl ethyl ketone and methyl isobutyl ketone; ester solvents such as ethyl acetate and butyl acetate; alcohol solvents such as methanol, ethanol, isopropanol, and butanol; and water. These solvents may be used alone, or two or more kinds of these solvents may also be used in combination.

To apply a resin mixture to a base film, any of the heretofore known thin film forming methods may be used, although it is not particularly limited. For example, there can be mentioned brush coating methods, spray coating methods, roll coating methods, bar coating methods, T-die coating methods, roll reverse coating methods, applicator coating methods, spin coating methods, dip coating methods, flow coating methods, gravure coating methods, MOCVD methods, CVD methods, and sputtering methods.

As a method of drying after a resin mixture is applied to a base film, any of the heretofore known drying methods may be employed, although it is not particularly limited. For example, there can be mentioned natural drying methods, air drying methods, hot-air drying methods, and infrared radiation methods. The drying temperature is generally in a range from room temperature to about 80° C. The drying time is generally 1 minute to 24 hours.

### Process for Producing Functional Thermoplastic Resin Sheet

The process for producing a functional thermoplastic resin sheet according to the first invention (hereinafter referred to sometimes as “the production process of the first invention”) comprises transferring, using a transfer film with a thin film of at least one layer formed on a surface of a base film, the thin film to an uneven surface of a thermoplastic resin sheet having the uneven surface, at which when the glass transition temperature of a thermoplastic resin sheet is denoted as Tg, a surface temperature of the thermoplastic resin sheet is in a range of not lower than (Tg−10° C.) and not higher than (Tg+70° C.), and a base film having a softening point lower than the surface temperature of the thermoplastic resin sheet is used. The term “the glass transition temperature (Tg) of a thermoplastic resin sheet” as used herein means a value measured by a DSC method in accordance with a DSC measurement method (a thermal fluid rate DSC) as defined in JIS K7121. Also, the term “a softening point of a base film” as used herein means a higher value of either the glass transition temperature (Tg) or the melting temperature (Tm) measured by a DSC method in accordance with a DSC measurement method (a thermal fluid rate DSC) as defined in JIS K7121. Further, the surface temperature of a thermoplastic resin sheet can be measured by a radiation thermometer.

<Production of Functional Thermoplastic Resin Sheet>

The functional thermoplastic resin sheet can be produced by pressure bonding the transfer film to an uneven surface of a thermoplastic resin sheet to transfer a thin film from the transfer film to the thermoplastic resin sheet. The transfer of a thin film may be carried out, for example, by heating a thermoplastic resin sheet which has been extruded and pressure bonding a transfer film at a specific temperature. However, it is preferred in consideration of production efficiency and the like that the pressure bonding of a transfer film is carried out in line during the extrusion of a thermoplastic resin sheet. In the extrusion of a thermoplastic resin sheet, any of the heretofore known sheet extruders may be employed, and in the pressure bonding of a transfer sheet, any of the heretofore known pressure bonding laminating machines may be employed. However, as pressure bonding rolls, relatively soft rolls such as rubber coated rolls may preferably be used instead of hard rolls. Additionally, it is required that in addition to the extrusion of a thermoplastic resin sheet, the pressure bonding of a transfer film is carried out at a specific temperature, and therefore, a pressure bonding laminating machine may be set at a place where the temperature of an extruded sheet becomes a specific temperature, or the surface temperature of an extruded sheet may be adjusted to a specific temperature at a place where a pressure bonding laminating machine is set.

In the production process of the first invention, a softening point of a base film used in a transfer film is selected so that it becomes lower than the surface temperature of a thermoplastic resin sheet at the time of transferring, and the surface temperature of a thermoplastic resin sheet at the time of transferring is set in a range of not lower than (Tg−10° C.) and not higher than (Tg+70° C.). This makes the base film a soft state at the time of transferring, so that the transfer film becomes to have high flexibility. Thus, it is possible to transfer a thin film by pressuring with relatively soft pressure bonding rolls such as rubber coated rolls, for example, while the transfer film enters into the concave portions on the surface of the thermoplastic resin sheet to follow its uneven surface.

The surface temperature of a thermoplastic resin sheet at the time of transferring may preferably be in a range of not lower than (Tg) and not higher than (Tg+50° C.), more preferably not lower than (Tg+10° C.) and not higher than (Tg+30° C.). When the surface temperature of a thermoplastic resin sheet at the time of transferring is lower than (Tg−10° C.), the adhesion of a thin film may be decreased. In contrast, when the surface temperature of a thermoplastic resin sheet at the time of transferring is higher than (Tg+70° C.), the uneven shape on the surface of the thermoplastic resin sheet cannot be maintained in some cases.

Additionally, the softened base film is solidified again by cooling after the transferring, so that it can easily be peeled off from the thermoplastic resin sheet. Also, since a base film becomes a soft state at the time of transferring, it is necessary to appropriately select a thermoplastic resin forming a thin film not so as to be mutually soluble with a thermoplastic resin forming a base film.

The conditions of extrusion in the production process of the first invention, such as a discharge rate from a die, a distance between the discharging outlet of a die and the cooling rolls, a rotational speed of the cooling rolls, and a rotational speed of take-up roll, are set to be substantially the same conditions as used in the case of the production of ordinary thermoplastic sheets, although they are not particularly limited. However, by adjusting a discharge rate from a die and the like, the surface temperature of a thermoplastic resin sheet at a position of pressure bonding rolls is required to be in a range of not lower than (Tg−10° C.) and not higher than (Tg+70° C.), when the glass transition temperature of the thermoplastic resin sheet is denoted as Tg. Additionally, in general, a position at which the surface temperature of an extruded sheet is near the glass transition temperature of the sheet moves to a downstream side along the machine direction of extrusion as a discharge rate from a die is increased, while it moves to an upstream side along the machine direction of extrusion as a discharge rate from a die is decreased. Additionally, a heating device such as heater may be provided, if necessary, before pressure bonding rolls.

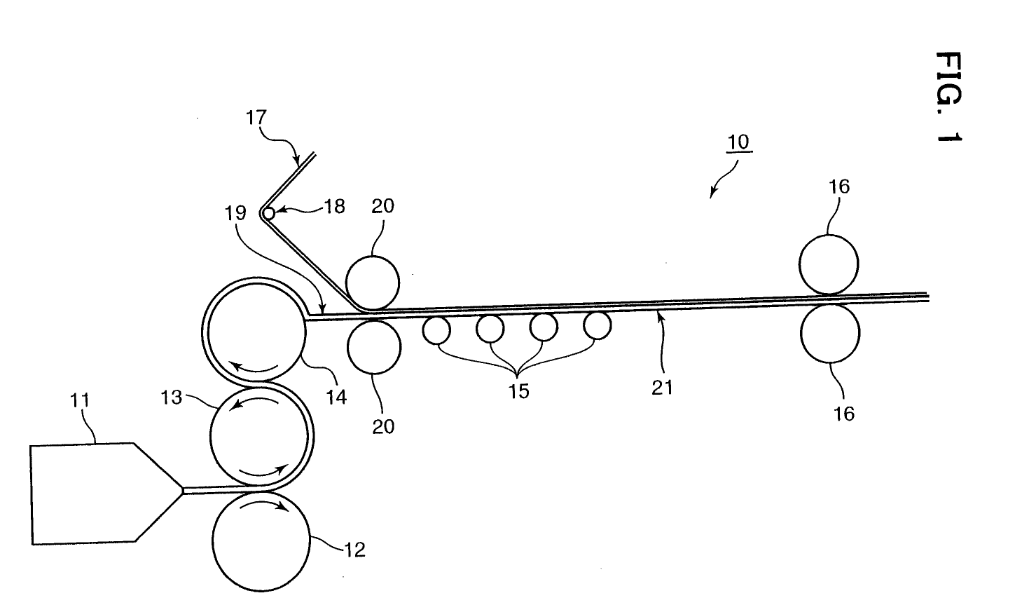

FIG. 1 shows a schematic view showing a typical sheet extruder which can be used in the production process of the first invention. The sheet extruder 10 is an ordinary sheet extruder composed of an extruder (not shown), a die 11, a first cooling roll 12, a second cooling roll 13, a third cooling roll 14, guide rolls 15, and take-up rolls 16, and further, a pressure bonding laminating machine is additionally set up between the third cooling roll 14 and the guide rolls 15. Additionally, the pressure bonding laminating machine is constituted in such a manner that a transfer film 17 is supplied under a tension imparted by a feed roll 18 and is pressure bonded on an uneven surface 19 of the extruded sheet by two pressure bonding rolls 20.

The step of producing a functional thermostatic resin sheet using the extruder as shown in FIG. 1 will be explained below. First, a thermostatic resin forming the sheet and, if necessary, various additives, are fed to an extruder (not shown), and after sufficient kneading, a sheet in a melt state is extruded from the die 11. The extruded sheet is introduced between the first cooling roll 12 and the second cooling roll 13, allowed to proceed on the periphery surface of the second cooling roll 13, subsequently, introduced between the second cooling roll 13 and the third cooling roll 14, allowed to proceed on the periphery surface of the third cooling roll 14, separated from the third cooling roll at the detachment position, stacked with the transfer film 17 under a tension imparted by the feed roll 18, pressure bonded by the pressure bonding rolls 20, allowed to passing through the guide rolls 15, and taken up by the take-up rolls 16. In this time, to give an uneven shape on a surface of the extruded sheet, for example, a decorating roll such as an emboss roll may be used as the second roll 13. Additionally, as the first cooling roll 12 and the third roll 14, mirror surface rolls with a flat surface are used. In this manner, a functional thermoplastic sheet 21 with a thin film of at least one layer transferred to the uneven surface can be obtained.

In the pressure bonding of a transfer film, it is possible for distortion to be few on a transfer bonding surface and to provide uniform transferring when it is pressure bonded under a tension of the transfer film (i.e., a tension per unit length in the width direction of rolls for feeding the transfer film) to be of not smaller than 0.01 kg/cm and not greater than 0.1 kg/cm, by pressure bonding rolls heated at a temperature of not lower than 30° C. and not higher than 200° C. under a linear pressure at a roll pressure (i.e., a roll pressure per unit length in the width direction of the rolls) of not smaller than 1 kg/cm and not greater than 10 kg/cm. When the tension of a transfer film is smaller than 0.01 kg/cm, wrinkles may occur in the transfer film. In contrast, when the tension of a transfer film is greater than 0.1 kg/cm, cracks may occur in a thin film due to the elongation of the transfer film. Also, when the temperature of pressure bonding rolls is lower than 30° C., the adhesion between the thermoplastic resin sheet and the thin film transferred may be low and wrinkles may occur at the time of pressure bonding. In contrast, when the temperature of pressure bonding rolls is higher than 200° C., the surface of the thermoplastic resin sheet may become coarse, undulation may become large, and a base film may be torn up. Further, when the roll pressure of heat pressure bonding rolls is smaller than 1 kg/cm, air may easily be sucked. In contrast, when the roll pressure of pressure bonding rolls is greater than 10 kg/cm, optical distortion may occur in the functional thermoplastic resin sheet obtained.

Additionally, when the feed roll of a transfer film is a roll of the expander roll system or the spiral roll system, it is preferred because the generation of wrinkles at the time of pressure bonding a transfer film can be prevented.

The functional thermoplastic resin sheet thus obtained has a thin film transferred to an uneven surface, and a base film still adheres to the thin film. This base film may be peeled off in a production step or on the occasion of using the functional thermoplastic resin sheet. Additionally, the peel strength of the base film after the thin film is transferred may preferably be not smaller than 0.02 N/cm and not greater than 1.0 N/cm. When the peel strength of the base film is in this range, it is possible to use the base film as a protective film for the thin film. The peel strength of the base film is a value measured by using a tensile tester into a 180° direction at a tensile speed of 300 mm/min.

According to the production process of the first invention, the use of a transfer method makes it possible to produce, with efficiency, a functional thermoplastic resin sheet having a thin film of at least one layer formed on an uneven surface thereof, which is industrially advantageous.

Next, as the second invention, light diffusion plates for liquid crystal display devices and their production process will be explained below.

### Light Diffusion Plate for Liquid Crystal Display Devices

The light diffusion plate for liquid crystal display devices according to the second invention (hereinafter referred to sometimes as “the light diffusion plate of the second invention”) is a light diffusion plate having a thin film of at least one layer on at least one side of a thermoplastic resin sheet, at least one layer of the thin film containing an antistatic agent(s). The term “at least one side” as used herein means a front face or a rear face of a thermoplastic resin sheet, or both thereof. Also, the term “a thin film of at least one layer” as used herein means the inclusion of cases in which the thin film is formed by a single layer and cases in which the thin film is formed by two or more layers.

As a specific structure of the light diffusion plate of the second invention, there can be mentioned, for example, a light diffusion plate having at least one layer of a thin film containing an antistatic agent(s) on one side of a thermoplastic resin sheet; a light diffusion plate having at least one layer of a thin film containing an antistatic agent(s) on both sides of a thermoplastic resin sheet; a light diffusion plate having at least one layer of a thin film containing an antistatic agent(s) and an ultraviolet absorbing agent(s) on one side of a thermoplastic resin sheet; a light diffusion plate having at least one layer of a thin film containing an ultraviolet absorbing agent(s) and at least one layer of a thin film containing an antistatic agent(s) on one side of a thermoplastic resin sheet in this order; a light diffusion plate having at least one layer of a thin film containing an antistatic agent(s) and at least one layer of a thin film containing an ultraviolet absorbing agent(s) on one side of a thermoplastic resin sheet in this order; a light diffusion plate having at least one layer of a thin film containing an antistatic agent(s) on one side of a thermoplastic resin sheet and at least one layer of a thin film containing an ultraviolet absorbing agent(s) on another side of the thermoplastic resin sheet; a light diffusion plate having at least one layer of a thin film containing an antistatic agent(s) on one side of a thermoplastic resin sheet, and at least one layer of a thin film containing an ultraviolet absorbing agent(s) and at least one layer of a thin film containing an antistatic agent(s) on another side of the thermoplastic resin sheet in this order; and a light diffusion plate having at least one layer of a thin film containing an antistatic agent(s) on one side of a thermoplastic resin sheet, and at least one layer of a thin film containing an antistatic agent(s) and at least one layer of a thin film containing an ultraviolet absorbing agent(s) on another side of the thermoplastic resin sheet in this order.

<Thermoplastic Resin Sheet>

In the light diffusion plate of the second invention, a thermoplastic resin sheet becomes a main body of the light diffusion plate. Therefore, the light diffusion plate should have light transparency. Specifically, a thermoplastic resin sheet may preferably have a haze of not lower than 0% and not higher than 20%, more preferably not lower than 0% and not higher than 10%, and/or, may preferably have a total light transmittance of not lower than 70% and not higher than 100%, more preferably not lower than 85% and not higher than 100%. Additionally, the haze and total light transmittance of a thermoplastic resin sheet are values measured by a measuring method in accordance with JIS K7105.

As a material of the thermoplastic resin sheet, there can be mentioned, for example, polycarbonate type resins; (meth)acrylic type resins such as poly(methyl methacrylate); styrene type resins such as polystyrene; acrylic-styrene copolymers; and cyclic olefin type resins such as norbornene type resins. In these thermoplastic resins, polycarbonate type resins may particularly be preferred.

The thermoplastic resin sheet may be made of a single material or of two or more kinds of materials, and also, may be formed by a single layer or by two or more layers.

The thickness of a thermoplastic resin sheet may preferably be not smaller than 0.5 mm and not greater than 5 mm, more preferably not smaller than 1 mm and not greater than 3 mm or less. When the thickness of a thermoplastic resin sheet is smaller than 0.5 mm, the mechanical strength of a light diffusion plate may be lowered. In contrast, when the thickness of a thermoplastic resin sheet is greater than 5 mm, the amount of light passing through the light diffusion plate may be reduced, resulting in a lowered brightness.

Additionally, in the production of a light diffusion plate, for example, transparent fine particles, a fluorescent whitener(s), and an antioxidant(s) are added to the thermoplastic resin in respectively appropriate amounts. In this case, the haze of a thermoplastic resin sheet may preferably be not smaller than 70%, more preferably not smaller than 80%, and still more preferably not smaller than 90%, and/or, the total light transmittance of a thermoplastic resin sheet may preferably be not smaller than 40%, more preferably not smaller than 50%, and still more preferably not smaller than 60%.

The brightness of light passing through a single thermoplastic resin sheet may preferably be not smaller than 2,500 cd/m², more preferably not smaller than 3,000 cd/m², and still more preferably not smaller than 3,500 cd/m². When the brightness is smaller than 2,500 cd/m², display images of liquid crystal display devices may become dark and clear images cannot be obtained in some cases. Since a thin film is transferred to the thermoplastic resin sheet, brightness may become lowered. The decreasing rate of brightness may preferably be not smaller than 20%, more preferably not smaller than 10%, and still more preferably not smaller than 5%. Additionally, the brightness of a single thermoplastic resin sheet is a value measured by the method described in Examples, and the decreasing rate of brightness is calculated by the formula:
[(brightness before thin film transfer−brightness after thin film transfer)/brightness before thin film transfer]×100 (%).

Additives may be added to a thermoplastic resin sheet, such as stabilizers, antioxidants, plasticizers, dispersants, and fluorescent whiteners. The amount of each of these additives to be added may appropriately be adjusted depending upon their kinds and the like, although it is not particularly limited.

The thermoplastic resin sheet contains fine particles to diffuse light from a light source uniformly and excellently. It is preferred that the fine particles contained in a thermoplastic resin sheet are substantially uniformly dispersed.

As a material of the fine particles, there can be mentioned, for example, synthetic resins such as (meth)acrylic type resins, styrene type resins, polyurethane type resins, polyester type resins, silicone type resins, fluorocarbon type resins, and copolymers thereof; glass; clay compounds such as smectite and kaolinite; and inorganic oxides such as silica and alumina. In these materials, silicone type resins and silica may particularly be preferred.

Since the shape of fine particles is the same as that of the fine particles to be contained in a thin film which will be explained below, their explanation is omitted here. However, the amount of fine particle to be used may preferably be not lower than 0.1 parts by weight and not higher than 20 parts by weight, more preferably not lower than 0.2 parts by weight and not higher than 10 parts by weight, relative to 100 parts by weight of a thermoplastic resin forming a sheet. When the amount of fine particles to be used is lower than 0.1 parts by weight, light incident to a thin film cannot sufficiently be diffused in some cases. In contrast, when the amount of fine particles to be used is higher than 20 parts by weight, the extrusion of a sheet may become difficult, or the amount of light passing through a thin film may be reduced, resulting in a lowered brightness.

The polycarabonate type resins which may particularly be preferred as a thermoplastic resin forming a sheet are obtained, for example, by reacting a divalent phenol with a carbonate precursor in an interfacial polycondensation method or melting method.

As the divalent phenol, there can be mentioned, for example, 2,2-bis(4-hydroxypheny)propane (common name, bisphenol A), 1,1-bis(4-hydroxyphenyl)ethane, 1,1-bis(4-hydroxyphenyl)cyclohexane, 2,2-bis-(3-methyl-4-hydroxyphenyl)propane, 2,2-bis-(3,5-dimethyl-4-hydroxyphenyl)propane, bis-(4-hydroxyphenyl)sulfide, and bis(4-hydroxy-phenyl)sulfone. These divalent phenols may be used alone, or two or more kinds of these divalent phenols may also be used in combination. In these divalent phenols, bisphenol A may particularly be preferred.

Also, as the carbonate precursor, there can be mentioned carbonyl halides, carbonate esters, and haloformates. Specifically, there can be mentioned, for example, phosgene, diphenyl carbonate, and dihaloformates of divalent phenols.

In the production of polycarbonate resins by reacting the divalent phenols and carbonate precursors in an interfacial polycondensation method or melting method, a catalyst(s), an end stopping agent(s), and an antioxidant(s) for divalent phenols may be used, if necessary.

Also, the polycarbonate type resin may be either a branched polycarbonate type resin in which a three or more functional aromatic compound is copolymerized, or a polyester-polycarbonate type resin in which an aromatic or aliphatic difunctional carboxylic acid is copolymerized, or a mixture of two or more kinds of the polycarbonate resins obtained.

The molecular weight of a polycarbonate type resin may preferably be not lower than 15,000 and not higher than 40,000, more preferably not smaller than 18,000 and not greater than 35,000, in terms of a viscosity average molecular weight. Additionally, the viscosity average molecular weight of a polycarbonate type resin is a value determined by inserting a specific viscosity (ηsp) measured at 20° C. from a solution of 0.7 g of the polycarbonate type resin dissolved in 100 mL of methylene chloride in the following formula:
ηsp/c=[η]+0.45×[η]²c
[η]=1.23×10⁻⁴M^{0.83}
wherein c=0.7, [η] is a limiting viscosity, and M is a viscosity average molecular weight.

To a polycarbonate type resin, additives may be added, if necessary, in such amounts that their performances can be exhibited, for example, including thermal stabilizers such as phosphorous acid, phosphoric acid, phosphite esters, phoshate esters, and phosphonic acid esters; ultraviolet absorbing agents such as triazole type, acetophenone type, and salicylic acid ester type; bluing agents; flame retardants such as tetrabromobisphenol A, low molecular weight polycarbonates of tetrabromo-bisphenol A, and decabromodiphenylene ether; and flame retardant auxiliaries such as antimony trioxide.

Also, phosphorous containing thermal stabilizers can be added to carbonate type resins for the purpose of preventing the molecular weight lowering and color deterioration in the formation. As the phosphorous containing thermal stabilizer, there can be mentioned, for example, phosphorous acid, phosphoric acid, phosphonous, phosphonic acid, and esters thereof, and there can be mentioned specifically, for example, triphenyl phosphite, tris(nonylphenyl) phosphite, tridecyl phosphite, trioctyl phosphite, trioctadecyl phosphite, didecylmonophenyl phosphite, dioctylmonophenyl phosphite, diisopropylmonophenyl phosphite, monobutyldiphenyl phosphite, monodecyldiphenyl phosphite, monooctyldiphenyl phosphite, tris(2,4-di-tert-butylphenyl) phosphite, bis(2,6-di-tert-butyl-4-methylphenyl)penta-erythritol diphosphite, 2,2-methylene bis(4,6-di-tert-butylphenyl)octyl phosphite, bis(nonylphenyl)pentaerythritol diphosphite, bis(2,4-di-tert-butylphenyl)pentaerythritol diphosphite, distearylpentaerythritol diphosphite, tributyl phosphate, triethyl phosphate, trimethyl phoshate, triphenyl phosphate, diphenyl monooxoxenyl phosphate, dibutyl phosphate, dioctyl phosphate, diisopropyl phosphate, tetrakis(2,4-di-isopropyl-phenyl)-4,4′-biphenylene diphosphonite, tetrakis(2,4-di-n-butylphenyl)-4,4′-biphenylene diphosphonite, tetrakis(2,4-di-tert-butyl-phenyl)-4,4′-biphenylene diphosphonite, tetrakis(2,4-di-tert-butylphenyl)-4,3′-biphenylene diphosphonite, tetrakis(2,4-di-tert-butyl-phenyl)-3,3′-biphenylene diphosphonite, tetrakis(2,6-diisopropylphenyl)-4,4′-biphenylene diphosphonite, tetrakis(2,6-di-n-butyl-phenyl)-4,4′-biphenylene diphosphonite, tetrakis(2,6-di-t-butylphenyl)-4,4′-biphenylene diphosphonite, tetrakis(2,6-di-t-butyl-phenyl)-4,3′-biphenylene diphosphonite, tetrakis(2,6-di-t-butylphenyl)-3,3′-biphenylene diphosphonite, bis(2,4-di-tert-butylphenyl)biphenyl phosphonite, dimethyl benzenephosphonate, diethyl benzenephosphonate, and dipropyl benzenephosphonate. These phosphorous containing thermal stabilizers may be used alone, or two or more kinds of these phosphorous containing thermal stabilizers may also be used in combination. In these phosphorous containing thermal stabilizers, tris(2,4-di-tert-butylphenyl) phosphite, tetrakis(2,4-di-tert-butylphenyl)-4,4′-biphenylene diphosphonite, and bis(2,4-di-tert-butylphenyl)-biphenyl phosphonite may particularly be preferred.

The amount of thermal stabilizer to be used may preferably be not smaller than 0.001 parts by weight and not greater than 0.15 parts by weight, relative to 100 parts by weight of a copolymerized polycarbonate type resin or a blend of polycarbonate type resins.

Further, polycarbonate type resins can contain aliphatic esters in order to improve a mold releasing property from a mold in the formation. As such aliphatic esters, there are preferred partial esters or entire esters of monohydric or polyhydric alcohols having from 1 to 20 carbon atoms with saturated fatty acids having from 10 to 30 carbon atoms. As such partial or entire esters of monohydric or polyhydric alcohols with saturated fatty acids, there can be mentioned, for example, stearic acid monoglyceride, stearic acid diglyceride, stearic acid triglyceride, stearic acid monosorbitate, behenic acid monoglyceride, pentaerythritol monostearate, pentaerythritol tetrastearate, pentaerythritol tetrapelagonate, propyleneglycol monostearate, stearyl stearate, palmityl palmitate, butyl stearate, methyl laurate, isopropyl palmitate, biphenyl biphenate, sorbitan monostearate, and 2-ethylhexyl stearate. These fatty acid esters may be used alone, or two or more kinds of these fatty acid esters may also be used in combination. In these fatty acid esters, stearic acid monoglyceride, stearic acid triglyceride, and pentaerythritol tetrastearate may particularly be preferred. The amount of such a fatty acid ester may preferably be not smaller than 0.001 parts by weight and not greater than 0.5 parts by weight, relative to 100 parts by weight of a copolymerized polycarbonate type resin or a blend of polycarbonate type resins.

To polycarbonate type resins, there can be added bluing agents in order that when the polycarbonate type resins are formed into a light diffusion plate, the yellowness of the light diffusion plate due to the polycarbonate type resins and ultraviolet absorbing agents can be cancelled out. As the bluing agent, any of those which are used for polycarbonate type resins can be used without any particular problem. In general, anthraquinone type dyes are easily available and preferred.

Specifically, typical examples of the bluing agent may include Solvent Violet 13 in the general name (CA. No. (color index No.) 60725; trade name “Macrolex Violet B” available from Bayer AG, “Dia Resin Blue G” available from Mitsubishi Chemical MKV Co., Ltd., and “Sumiplast Violet B” available from Sumitomo Chemical Co., Ltd.), Solvent Violet 31 in the general name (CA. No. 68210; trade name “Dia Resin Violet D” available from Mitsubishi Chemical MKV Co., Ltd.), Solvent Violet 33 in the general name (CA. No. 60725; trade name “Dia Resin Blue J” available from Mitsubishi Chemical MKV Co., Ltd.), Solvent Blue 94 in the general name (CA. No. 61500; trade name “Dia Resin Blue N” available from Mitsubishi Chemical MKV Co., Ltd.), Solvent Violet 36 in the general name (CA. No. 68210; trade name “Macrolex Violet 3R” available from Bayer AG), Solvent Blue 97 in the general name (trade name, “Microlex Violet RR” available from Bayer AG), and Solvent Blue 45 in the general name (CA. No. 61110; trade name, “Tetrazole Blue RLS” available from Sandoz AG). Each of these bluing agents may preferably be added in a ratio of not smaller than 0.3×10⁻⁴ parts by weight and not greater than 2×10⁻⁴ parts by weight, relative to 100 parts by weight of a polycarbonate based resin.

<Thin Film>

In the light diffusion plate of the second invention, a thin film is formed on one side or both sides of a thermoplastic resin sheet. As a material forming a thin film, there can be mentioned, for example, (meth)acrylic type resins, polyester type resins, epoxy type resins, and silicone type resins. These resins may be used alone, or two or more kinds of these resins may also be used in combination. In these resins, (meth)acrylic type resins are particularly preferable.

As a monomer forming the particularly preferable (meth)acrylic type resin, there can be mentioned, for example, (meth)acrylic acid; (meth)acrylic acid esters such as methyl (meth)acrylate, ethyl (meth)acrylate, butyl (meth)acrylate, cyclohexyl (meth)acrylate, phenyl (meth)acrylate, benzyl (meth)acrylate, 2-ethylhexyl (meth)acrylate, and 2-hydroxyethyl (meth)acrylate. These monomers may be used alone, or two or more kinds of these monomers may also be used in combination.

Also, in addition to the above monomers, to the extent that the gists of the second invention are not deteriorated, for example, there may be copolymerized with any other monomers such as unsaturated acids, e.g., acrylic acid and methacylic acid; styrene, butadiene, isoprene, α-methylstyrene, (meth)acrylonitrile, maleic anhydride, phenylmaleimide, and cyclohexylmaleimide. These other monomers may be used alone, or two or more kinds of these other monomers may also be used in combination.

Also, (meth)acrylic type resins may have a crosslinked structure. As a crosslinker, there can be mentioned, for example, multifunctional vinyl compounds such as ethylene glycol di(meth)acrylate, p- or m-divinylbenzene, and trimethylolpropane tri(meth)acryalte. There may be used isocyanate compounds including blocked isocyanates; epoxy compounds; aziridine compounds; oxazoline compounds; and multifunctional acid anhydride. These crosslinkers may be used alone, or two or more kinds of these crosslinkers may also be used in combination.

In the polymerization of (meth)acrylic type resins, there can be added a monomer(s) having an antistatic property and/or a monomer(s) having an ultraviolet absorption property. Also, if necessary, various additives may be incorporated into the polymerization system, including polymerization retardants, chain transfer agents, polymerization accelerators, defoaming agents, leveling agents, mold releasing agents, and surfactants.

As a monomer having an ultraviolet absorption property, there can be mentioned, for example, benzotriazoles shown by the following formula (1) or (2): 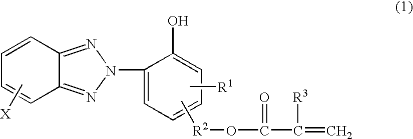
wherein R¹ is a hydrogen atom or a hydrocarbon group having from 1 to 8 carbon atoms; R² is an alkylene group having from 1 to 6 carbon atoms; R³ is a hydrogen atom or a methyl group; and X is a hydrogen atom, a halogen atom, a hydrocarbon group having from 1 to 8 carbon atoms, an alkoxy group having from 1 to 6 carbon atoms, a cyano group, or a nitro group.

In the above formula (1), as the hydrocarbon group having from 1 to 8 carbon atoms, which is expressed by R¹, there can be mentioned, for example, linear hydrocarbon groups such as methyl group, ethyl group, propyl group, isopropyl group, butyl group, isobutyl group, tert-butyl group, pentyl group, hexyl group, heptyl group, and octyl group; alicyclic hydrocarbon groups such as cyclopropyl group, cyclopentyl group, cyclohexyl group, cyclohepthyl group, and cyclooctyl group; aromatic hydrocarbon groups such as phenyl group, tolyl group, xylyl group, benzyl group, and phenetyl group. As the alkylene group having from 1 to 6 carbon atoms, which is expressed by R², there can be mentioned, for example, linear alkylene groups such as methylene group, ethylene group, trimetylene group, and tetramethylene group; branched alkylene groups such as propylene group, 2-methyltrimethylene group, and 2-methyltetramethylene group. As the halogen atom expressed by X, there can be mentioned, for example, fluorine atom, chlorine atom, bromine atom, and iodine atom. As the hydrocarbon group having from 1 to 8 carbon atoms, which is expressed by X, there can be mentioned, for example, linear hydrocarbon groups such as methyl group, ethyl group, propyl group, isopropyl group, butyl group, isobutyl group, tert-butyl group, pentyl group, hexyl group, heptyl group, and octyl group; alicyclic hydrocarbon groups such as cyclopropyl group, cyclopentyl group, cyclohexyl group, cyclohepthyl group, and cyclooctyl group; aromatic hydrocarbon groups such as phenyl group, tolyl group, xylyl group, benzyl group, and phenetyl group. As the alkoxy groups having from 1 to 6 carbon atoms, which is expressed by X, there can be mentioned, for example, methoxy group, ethoxy group, propoxy group, butoxy group, pentoxy group, and hexoxy group.

As specific examples of the monomer having an ultraviolet absorption property, which is shown by the above formula (1), there can be mentioned, for example, 2-[2′-hydroxy-5′-(methacryloyloxymethyl)phenyl]-2H-benzotriazole, 2-[2′-hydroxy-5′-(methacryloyloxy-ethyl)phenyl]-2H-benzotriazole, 2-[2′-hydroxy-5′-(methacryloyloxypropyl)phenyl]-2H-benzotriazole, 2-[2′-hydroxy-5′-(methacryloyloxyhexyl)phenyl]-2H-benzotriazole, 2-[2′-hydroxy-3′-tert-butyl-5′-(methacryloyloxyethyl)phenyl]-2H-benzotriazole, 2-[2′-hydroxy-5′-tert-butyl-3′-(methacryloyloxy-ethyl)phenyl]-2H-benzotriazole, 2-[2′-hydroxy-5′-(methacryloyloxyethyl)phenyl]-5-chloro-2H-benzotriazole, 2-[2′-hydroxy-5′-(methacryloyloxy-ethyl)phenyl]-5-methoxy-2H-benzotriazole, 2-[2′-hydroxy-5′-(methacryloyloxyethyl)phenyl]-5-cyano-2H-benzotriazole, 2-[2′-hydroxy-5′-(methacryloyloxyethyl)phenyl]-5-tert-butyl-2H-benzotriazole, and 2-[2′-hydroxy-5′-(methacryloyl-oxyethyl)phenyl]-5-nitro-2H-benzotriazole, although it is not particularly limited thereto. Additionally, these monomers having an ultraviolet absorption property, which are shown by the above formula (1), may be used alone, or two or more kinds of these monomers may also be used in combination. 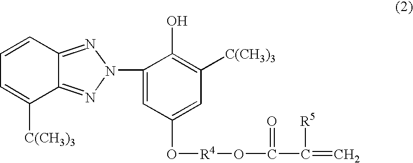
wherein R⁴ is an alkylene group having 2 or 3 carbon atoms; and R⁵ is a hydrogen atom or a methyl group.

In the above formula (2), as the alkylene group having 2 or 3 carbon atoms, which is expressed by R⁴, there can be mentioned, for example, ethylene group, trimethylene group, and propylene group.

As specific examples of the monomer having an ultraviolet absorption property, which is shown by the above formula (2), there can be mentioned, for example, 2-[2′-hydroxy-5′-(β-methacryloyloxyethoxy)-3′-tert-butylphenyl]-4-tert-butyl-2H-benzotriazole, although it is not limited thereto. Additionally, the monomers having an ultraviolet absorption property, which are shown by the above formula (2), may be used alone, or two or more kinds of these monomers may also be used in combination.

Also, in the case of using the monomer having an ultraviolet absorption property, which is shown by the above formula (1) or (2), it is preferred to use at least one kind selected from monomers having an ultraviolet absorption property, which are shown by the following formula (3) or (4): 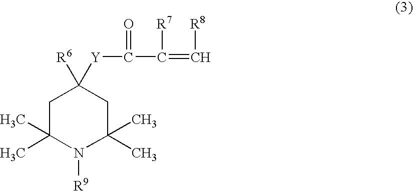
wherein R⁶ is a hydrogen atom or a cyano group; R⁷ and R⁸ each independently is a hydrogen atom or a methyl group; R⁹ is a hydrogen atom or a hydrocarbon group having from 1 to 18 carbon atoms; and Y is an oxygen atom or an imino group.

In the above formula (3), as the hydrocarbon group having from 1 to 18 carbon atoms, which is shown by R⁹, there can be mentioned, for example, linear hydrocarbon groups such as methyl group, ethyl group, propyl group, isopropyl group, butyl group, isobutyl group, ter-butyl group, pentyl group, hexyl group, heptyl group, octyl group, nonyl group, decyl group, undecyl group, dodecyl group, tridecyl group, tetradecyl group, pentadecyl group, hexadecyl group, heptadecyl group, and octadecyl group; alicyclic hydrocarbon groups such as cyclopropyl group, cyclopentyl group, cyclohexyl group, cyclohepthyl group, and cyclooctyl group; aromatic hydrocarbon groups such as phenyl group, tolyl group, xylyl group, benzyl group, and phenetyl group.

As specific examples of the monomer having an ultraviolet absorption property, which is shown by the above formula (3), there can be mentioned, for example, 4-(meth)acryloyloxy-2,2,6,6-tetramethylpiperidine, 4-(meth)acryloylamino-2,2,6,6-tetramethylpiperidine, 4-(meth)acryloyloxy-1,2,2,6,6-pentamethylpiperidine, 4-(meth)acryloylamino-1,2,2,6,6-pentamethylpiperidine, 4-cyano-4-(meth)acryloylamino-2,2,6,6-tetramethylpiperidine, 4-crotonoyloxy-2,2,6,6-tetramethylpiperidine, and 4-crotonoylamino-2,2,6,6-tetramethylpiperidine, although it is not particularly limited thereto. Additionally, the monomers having an ultraviolet absorption property, which are shown by the above formula (3), may be used alone, or two or more kinds of these monomers may also be used in combination. 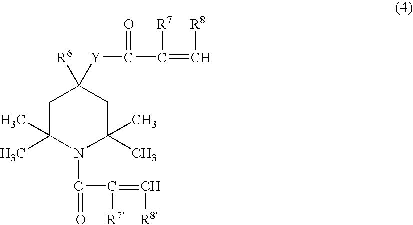
wherein R⁶ is a hydrogen atom or a cyano group; R⁷, R⁸, R^{7′}, and R^{8′} each independently is a hydrogen atom or a methyl group; and Y is an oxygen atom or an imino group.

As specific examples of the monomer having an ultraviolet absorption property, which is shown by the above formula (4), there can be mentioned, for example, 1-(meth)acryloyl-4-(meth)acryloylamino-2,2,6,6-tetramethylpiperidine, 1-(meth)acryloyl-4-cyano-4-(meth)acryloylamino-2,2,6,6-tetramethylpiperidine, and 1-crotonoyl-4-crotonoyloxy-2,2,6,6-tetramethylpiperidine, although it is not particularly limited thereto. Additionally, the monomer having an ultraviolet absorption property, which is shown in the above formula (4), may be used alone, or two or more kinds of these monomers may also be used in combination.

Additionally, as a commercially available acrylic type resin containing a structure unit derived from a monomer having an ultraviolet absorption property, there can be mentioned, for example, HALS-hybrid UV-G series “UV-G714”, “UV-G301”, and “UV-G302”, all available from Nippon Shokubai Co., Ltd., which are easily industrially available and therefore most suitable.

As the method of polymerizing the above monomers, any of the heretofore known polymerization methods may be employed, although it is not particularly limited, and there can be mentioned, for example, bulk polymerization, solution polymerization, emulsion polymerization, suspension polymerization, and dispersion polymerization. In these polymerization methods, solution polymerization may particularly be preferred, in which a solvent having good solubility to an additive(s) such as an antistatic agent(s) and/or an ultraviolet absorbing agent(s) is used.

The thin film may be made of a single material or of two or more kinds of materials, and also, may be formed by a single layer or by two or more layers.

However, for the purpose of preventing the adhesion of dust, at least one layer of a thin film is required to contain an antistatic agent(s). Also, for the purpose of preventing the deterioration due to light from a light source, at least one layer of a thin film, preferably at least one layer of a thin film on the side receiving light from a light source is required to contain an ultraviolet absorbing agent(s) or is made of a thermoplastic resin(s) having an ultraviolet absorption property.

The thickness of a thin film (or the thickness of each layer in the case of a thin film formed by two or more layers) may preferably be not smaller than 0.01 μm and not greater than 30 μm, more preferably not smaller than 0.05 μm and not greater than 20 μm, and still more preferably not smaller than 0.1 μm and not greater than 10 μm. When the thickness of a thin film is smaller than 0.01 μm, the effect of preventing the adhesion of dust or the deterioration due to light from a light source may be small, and the formation of a uniform thin film may become difficult. In contrast, when the thickness of a thin film is greater than 30 μm, in the case where a material different from the thermoplastic resin sheet is used, warping may occur due to a difference in the thermal shrinkage ratio or a difference in the water absorption. Additionally, the thickness of a thin film is a value measured by the method described in Examples.

To a thin film, additives may be added, including stabilizers, antioxidants, plasticizers, and dispersers. The amount of each of these additives to be used may appropriately be adjusted depending upon their kinds and the like, although it is not particularly limited.

<Antistatic Agent>

In the light diffusion plate of the second invention, at least one layer of a thin film contains an antistatic agent(s). The term “at least one layer of a thin film” as used herein means, in the case where a thin film is formed by a single layer, the thin film itself, and in the case where a thin film is formed by two or more layers, at least one layer in two or more layers of this thin film. The reason for an antistatic compound(s) being contained in at least one layer of a thin film is for the purpose of preventing the influence of dust existing in air.

As the antistatic agent to be used in a thin film, any of the heretofore known antistatic agents may be used. As the antistatic agent of the organic type, there can be mentioned various surfactants and electrically conductive resins. As the antistatic agent of the inorganic type, there can be mentioned various electrically conductive fine particles.

As the surfactant which can be used as an antistatic agent, there can be mentioned, for example, anionic surfactants such as olefin type sulfate esters or their metal salts including alkylsulfuric acid, alkylbenzene sulfuric acid, and their Li, Na, Ca, Mg, and Zn salts, and phosphate esters of higher alcohols; cationic surfactants such as tertiary amines, quaternary ammonium salts, cationic acrylate ester derivatives, and cationic vinyl ether derivatives; amphoteric surfactants such as alkylamine type betaine amphoteric salts, amphoteric salts of alanine with carboxylic acids or sulfonic acids, and amphoteric salts of alkylimidazoline; and nonionic surfactants such as esters of fatty acids with polyhydric alcohols and polyoxyethylene adduct of alkylamines. As the electrically conductive resin which can be used as an antistatic agent, there can be mentioned, for example, polyvinylbenzyl type cationic resins and polyacrylic acid type cationic resins. These antistatic agents of the organic type may be used alone, or two or more kinds of these antistatic agents of the organic type may also be used in combination. In these antistatic agents of the organic type, cationic surfactants such as tertiary amines and quaternary ammonium salts may particularly be preferred.

As the electrically conductive fine particles which can be used as an antistatic agent, there can be mentioned, for example, in addition to antimony doped tin oxide and phosphorous doped tin oxide, inorganic fine particles such as antimony oxide, zinc antimonate, titanium oxide, and ITO (indium tin oxide). These inorganic fine particles may be used alone, or two or more kinds of these inorganic fine particles may also be used in combination.

The electrically conductive fine particles may preferably have an average particle diameter of not smaller than 1 nm and not greater than 200 nm, more preferably not smaller than 1 nm and not greater than 100 nm. When the average particle diameter is smaller than 1 nm, electrically conductive fine particles may easily cause coagulation, so that it becomes difficult to handle. In contrast, when the average particle diameter is greater than 200 nm, electrically conductive fine particles may scatter light, so that clouding may occur in a thin film to deteriorate the transparency of the thin film. Additionally, the average particle diameter of electrically conductive fine particles can be measured, for example, by a dynamic light scattering method or an image analysis method with an electron microscope.

The electrically conductive fine particles may be treated, for example, with an anionic surfactant(s), a cationic surfactant(s), a non-ionic surfactant(s), a silane type coupling agent(s), and an aluminum type coupling agent(s).

The electrically conductive fine particles may be used in powder form or in dissolved or dispersed form in a solvent. As the solvent which can be used, it is not particularly limited, so long as it dissolves or disperses electrically conductive fine particles, and evaporates after a thin film is formed. For example, there can be mentioned organic solvents including alcohols such as methanol, ethanol, isopropyl alcohol, and diacetone alcohol; ketones such as acetone, methyl ethyl ketone, and methyl isobutyl ketone; aromatic hydrocarbons such as toluene and xylene; esters such as ethyl acetate; and water. These solvents may be used alone, or two or more kinds of these solvents may also be used in combination.

The amount of antistatic agent to be used may preferably be not smaller than 0.1 parts by weight and not greater than 100 parts by weight, more preferably not smaller than 0.2 parts by weight and not greater than 70 parts by weight, and still more preferably not smaller than 0.3 parts by weight and not greater than 50 parts by weight, relative to 100 parts by weight of a resin(s) forming a thin film containing the antistatic agent. When the amount is smaller than 0.1 parts by weight, the effect of preventing the adhesion of dust may be small. In contrast, when the amount is greater than 100 parts by weight, the effect of preventing the adhesion of dust may be saturated.

The light diffusion plate of the second invention has at least one layer of a thin film containing an antistatic agent(s), so that it exhibits a resistance to the adhesion of dust, i.e., dust-proofness. Specifically, the surface resistivity on a thin film side containing an antistatic agent(s) may preferably be not higher than 10¹⁴ Ω, more preferably not higher than 10¹³ Ω, and still more preferably not higher than 10¹² Ω. When the surface resistivity is higher than 10¹⁴ Ω, the adhesion of dust or the malfunction of a device cannot be prevented in some cases. The term “surface resistivity” as used herein means a value measured in such a manner that a measuring sample is allowed to stand under an atmosphere at a temperature of 23° C. and a humidity of 60% RH for 24 hours, and then it is measured for surface resistivity using a high resistance meter at a measuring voltage of 250 V for a charge time of 60 seconds.

<Ultraviolet Absorbing Agent>

In the light diffusion plate of the second invention, at least one layer of a thin film may preferably contain an ultraviolet absorbing agent(s) The term “at least one layer of a thin film” as used herein means, in the case where a thin film is formed by a single layer, the thin film itself, and in the case where a thin film is formed by two or more layers, at least one layer in two or more layers of this thin film. A thin film containing an ultraviolet absorbing agent(s) may preferably be formed on the surface of a light diffusion plate on which side the plate receives light from a light source. This is because preventing the influence of light is intended. Therefore, when a thin film containing an ultraviolet absorbing agent(s) is formed, a light diffusion plate has a high light resistance, so that display images of liquid crystal display devices can be stabilized for a long period of time and their display quality can be improved.

As the ultraviolet absorbing agent, any of the heretofore known ultraviolet absorbing agents may be used, although it is not particularly limited. For example, there can be mentioned salicylic acid phenyl ester type ultraviolet absorbing agents, benzophenone type ultraviolet absorbing agents, triazine type ultraviolet absorbing agents, benzotriazole type ultraviolet absorbing agents, cyclic imino ester type ultraviolet absorbing agents, hindered amine type ultraviolet absorbing agents, and hybrid type ultraviolet absorbing agent containing both a hindered phenol structure and a hindered amine structure in a molecule.

As the salicylic acid phenyl ester type ultraviolet absorbing agent, there can be mentioned specifically, for example, phenyl salicylate, p-tert-butylphenyl salicylate, and p-octylphenyl salicylate are listed.

As the benzophenone type ultraviolet absorbing agent, there can be mentioned specifically, for example, 2,4-dihydroxybenzophenone, 2-hydroxy-4-methoxy-benzophenone, 2-hydroxy-4-octoxybenzophenone, 2-hydroxy-4-benziloxybenzophenone, 2-hydroxy-4-methoxy-5-sulfoxy-benzophenone, 2-hydroxy-4-methoxy-5-sulfoxytrihydrideratebenzophenone, 2,2′-dihydroxy-4-methoxybenzophenone, 2,2′,4,4′-tetrahydroxybenzophenone, 2,2′-dihydroxy-4,4′-dimethoxybenzophenone, 2,2′-dihydroxy-4,4′-dimethoxy-5-sodiumsulfoxy-benzophenone, bis(5-benzoyl-4-hydroxy-2-methoxy-phenyl)methane, 2-hydroxy-4-n-dodecyloxy-benzophenone, and 2-hydroxy-4-methoxy-2′-carboxy-benzophenone.

As the triazine type ultraviolet absorbing agent, there can be mentioned specifically, for example, 2-(4,6-diphenyl-1,3,5-triazin-2-yl)-5-hexyloxy-phenol.

As the benzotriazole type ultraviolet absorbing agent, there can be mentioned specifically, for example, 2-(2-hydroxy-5-methylphenyl)benzotriazole, 2-(2-hydroxy-5-tert-octylphenyl)benzotriazole, 2-(2-hydroxy-3,5-dicumylphenyl)phenylbenzotriazole, 2-(2-hydroxy-3-tert-butyl-5-methylphenyl)-5-chloro-benzotriazole, 2,2′-methylenebis[4-(1,1,3,3-tetra-methylbutyl)-6-(2H-benzotrialzol-2-yl)phenol], 2-(2-hydroxy-3,5-di-tert-butylphenyl)benzotriazole, 2-(2-hydroxy-3,5-di-tert-butylphenyl)-5-chloro-benzotriazole, 2-(2-hydroxy-3,5-di-tert-amyl-phenyl)benzotriazole, 2-(2-hydroxy-5-tert-octyl-phenyl)benzotriazole, 2-(2-hydroxy-5-tert-butyl-phenyl)benzotriazole, 2-(2-hydroxy-4-octoxy-phenyl)benzotriazole, 2,2′-methylene-bis(4-cumyl-6-benzotriazolephenyl), 2,2′-p-phenylenebis(1,3-benzooxazin-4-one), and 2-[2-hydroxyl-3-(3,4,5,6-tetrahydrophtalimide-methyl)-5-methylphenyl]benzotriazole.

As the cyclic imino ester type ultraviolet absorbing agent, there can be mentioned specifically, for example, 2,2′-p-phenylenebis(3,1-benzo-oxazin-4-one), 2,2′-(4,4′-diphenylene)-bis(3,1-benzooxazin-4-one), and 2,2′-(2,6-naphthalene)bis(3,1-benzooxazin-4-one).

As the hindered amine type ultraviolet absorbing agent, there can be mentioned specifically, for example, bis(2,2,6,6)-tetramethyl-4-piperidyl)sebacate and bis(1,2,2,6,6)-pentamethyl-4-piperidyl)sebacate.

As the hybrid type ultraviolet absorbing agent containing both a hindered phenol structure and a hindered amine structure in a molecule, there can be mentioned specifically, for example, 2-(3,5-di-tert-butyl-4-hydroxybenzyl)-2-n-butylmalonic acid bis(1,2,2,6,6-pentamethyl-4-piperidyl), and 1-[2-[3-(3,5-di-tert-butyl-4-hydroxyphenyl)-propionyloxy]ethyl]-4-[3-(3,5-di-tert-butyl-4-hydroxyphenyl)propionyloxy]-2,2,6,6-tetramethyl-piperidine.

These ultraviolet absorbing agents may be used alone, or two or more kinds of these ultraviolet absorbing agents may also be used in combination. In these ultraviolet absorbing agents, there may particularly be preferred 2-hydroxy-4-n-octoxy-benzophenone, 2-(4,6-diphenyl-1,3,5-triazin-2-yl)-5-hexyloxyphenol, 2-(2-hydroxy-5-tert-octyl-phenyl)benzotriazole, 2-(2-hydroxy-3,5-dicumyl-pheyl)phenylbenzotriazole, 2-(2-hydroxy-3-tert-butyl-5-methylphenyl)-5-chlorobenzotriazole, 2,2′-methylenebis[4-(1,1,3,3-tetramethylbutyl)-6-(2H-benzotrialzol-2-yl)phenol], and 2,2′-p-phenylenebis(3,1-benzooxazin-4-one).

The amount of ultraviolet absorbing agent to be used may preferably be not smaller than 0.5 parts by weight and not greater than 50 parts by weight, more preferably not smaller than 0.8 parts by weight and not greater than 40 parts by weight, and still more preferably not smaller than 1 part by weight and not greater than 30 parts by weight, relative to 100 parts by weight of a resin(s) forming a thin film containing the ultraviolet absorbing agent. When the amount of ultraviolet absorbing agent to be used is smaller than 0.5 parts by weight, the effect of preventing the influence of light from a light source may be small. In contrast, when the amount of ultraviolet absorbing agent to be used is greater than 50 parts by weight, the effect of preventing the influence of light from a light source may be saturated.

The light diffusion plate of the second invention may preferably have at least one layer of a thin film containing an ultraviolet absorbing agent(s), so that it exhibits a resistance to the deterioration due to light from a light source, i.e., a light resistance. Specifically, a surface resistivity after an accelerated light resistance test (i.e., ultraviolet radiation with an intensity of 100 mW/cm² at 63° C. for 20 hours) may preferably be not higher than 1×10¹⁴ Ω, more preferably not higher than 1×10¹³ Ω, and still more preferably not higher than 1×10¹² Ω, and a decreasing rate of brightness may preferably be not higher than 20%, more preferably not higher than 10%, and still more preferably not higher than 5%. When the surface resistivity is higher than 1×10¹⁴ Ω, the adhesion of dust and the malfunction of a device cannot be prevented in some cases. When the decreasing rate of brightness is higher than 20%, display images of liquid crystal display devices may become dark due to aging and clear images cannot be obtained in some cases. Additionally, the surface resistivity and brightness of a light diffusion plate are values measured by a method described in Examples, the decreasing rate of brightness after an accelerated light resistance test is calculated by the formula: [(brightness before ultraviolet irradiation−brightness after ultraviolet irradiation)/brightness before ultraviolet irradiation]×100 (%).

<Fluorescent Whitener>

In the light diffusion plate of the second invention, at least one layer of a thin film may preferably contain a fluorescent whitener(s). The term “at least one layer of a thin film” as used herein means, in the case where a thin film is formed by a single layer, the thin film itself, and in the case where a thin film is formed by two or more layers, at least one layer in two or more layers of this thin film. The fluorescent whitener has the action of absorbing the energy of an ultraviolet ray contained in light from a light source and changing this energy into a visible light. Therefore, when a thin film containing an ultraviolet absorbing agent(s) is provided, the loss of light due to the refraction and absorption of light can be compensated to improve the uniformity and brightness of light.

As the fluorescent whitener, any of the heretofore known fluorescent whiteners may be used, although it is not particularly limited. For example, there can be mentioned oxazole type fluorescent whiteners, cumarin type fluorescent whiteners, stilbene type fluorescent whiteners, imidazole type fluorescent whiteners, triazole type fluorescent whiteners, naphthalimide type fluorescent whiteners, and rhodamine type fluorescent whiteners. These fluorescent whiteners may be used alone, or two or more kinds of these fluorescent whiteners may also be used in combination. In these fluorescent whiteners, oxazole type fluorescent whiteners and cumarin type fluorescent whiteners may particularly be preferred.

The amount of fluorescent whitener to be used may preferably be not smaller than 0.0005 parts by weight and not greater than 50 parts by weight, more preferably not smaller than 0.001 parts by weight and not greater than 30 parts by weight, relative to 100 parts by weight of a resin(s) forming a thin film containing the fluorescent whitener. When the amount of fluorescent whitener to be used is smaller than 0.0005 parts by weight, the effect of improving the uniformity and brightness of light may be small. In contrast, when the amount of fluorescent whitener to be used is greater than 50 parts by weight, the uniformity of light may rather be deteriorated or the mechanical strength of the thin film may be deteriorated, and also, it may result in using an expensive fluorescent whitener(s) more than necessary and increasing production costs.

<Fine Particles>

In the light diffusion plate of the second invention, at least one layer of a thin film may preferably contain fine particles. The term “at least one layer of a thin film” as used herein means, in the case where a thin film is formed by a single layer, the thin film itself, and in the case where a thin film is formed by two or more layers, at least one layer of two or more layers of this thin film. The fine particles diffuse light from a light source uniformly and excellently, so that the uniformity and brightness of light can be improved. It is preferred that the fine particles contained in a thin film are substantially uniformly dispersed.

As a material of the fine particle, there can be mentioned, for example, synthetic resins such as (meth)acrylic type resins, styrene type resins, polyurethane type resins, polyester type resins, silicone type resins, fluorocarbon type resins, and copolymers thereof; glass; clay compounds such as smectite and kaolinite; and inorganic oxides such as silica and alumina. In these materials, (meth)acrylic type resins, styrene type resins, acrylic-styrene copolymers, silicone type resins, and silica may particularly be preferred.

The fine particles may be made of a single material or of two or more kinds of materials, and also, may be formed by one kind of fine particle made of the same material or by two or more kinds of fine particles made of different materials.

The shapes of fine particles may be, for example, spherical, flat, elliptical, polygonal, and platy. The fine particles having these shapes may be used alone, or two or more kinds of fine particles having these shapes may also be used in combination. In the fine particles having these shapes, spherical particles may be preferred, but there are cases where non-spherical particle such as flat, elliptical, polygonal, and platy particles are preferred because of their having a light diffusion property stronger than spherical particles and their being capable of obtaining high brightness with a small amount for addition.

The average particle diameter of fine particles may preferably be not smaller than 0.1 μm and not greater than 30 μm, more preferably not smaller than 0.5 μm and not greater than 25 μm, and still more preferably not smaller than 1 μm and not greater than 20 μm. When the average particle diameter of fine particles is smaller than 0.1 μm, light incident to a thin film cannot sufficiently be diffused in some cases. In contrast, when the average particle diameter of fine particles is greater than 30 μm, the amount of light passing through a thin film may be reduced, resulting in a lowered brightness. Additionally, the average particle diameter of fine particle is a simply averaged value of particle diameters for which arbitrary hundred fine particles are measured with a microscope. Also, in the case of each fine particle with a non-spherical shape, an average of the maximum diameter and the minimum diameter is defined as the average diameter.

The amount of fine particles to be used may preferably be not smaller than 1 part by weight and not greater than 200 parts by weight, more preferably not smaller than 5 parts by weight and not greater than 150 parts by weight, and still more preferably not smaller than 10 parts by weight and not greater than 100 parts by weight, relative to 100 parts by weight of a resin(s) containing the fine particles. When the amount of fine particles to be used is smaller than 1 part by weight, light incident to a thin film cannot sufficiently be diffused in some cases. In contrast, when the amount of fine particles to be used is greater than 200 parts by weight, the formation of a thin film may become difficult, or the amount of light passing through a thin film may be reduced, resulting in a lowered brightness.

<Applications of Light Diffusion Plate>

The light diffusion plate of the second invention can be used as a light diffusion plate for any of the heretofore known direct type backlight units or side light type backlight units, in which display images of liquid crystal display devices can be stabilized for a long period of time and their display quality can be improved; therefore, it is preferred to be used as a light diffusion plate in a direct type backlight unit for a large size liquid crystal display devices used in liquid crystal television sets exceeding 15 inches and desktop personal computers.

### Process for Producing Light Diffusion Plate

The process for producing a light diffusion plate according to the second invention comprises extruding a thermoplastic resin sheet while transferring, using a transfer film with a thin film formed on a surface of a base film, the thin film of at least one layer on at least one side of the thermoplastic resin sheet.

<Preparation of Transfer Film>

To transfer a thin film to a thermoplastic resin sheet, first, a resin forming the thin film and a desired additive such as an antistatic agent(s) and an ultraviolet absorbing agent(s) are dissolved or dispersed in an organic solvent to prepare a resin mixture, and then, the resin mixture is applied to the surface of a base film, followed by drying, to prepare a transfer film with a thin film formed on the surface of the base film. Additionally, in the case where a thin film is formed by two or more layers, a step of applying a resin mixture corresponding to each of the layers to the surface of a base film, followed by drying, will repeatedly be carried out.

As the base film, there can be mentioned, for example, polyethylene films, biaxially oriented polypropylene films, biaxially oriented polyamide films, biaxially oriented polyester films (poly-ethyleneterephthalate, polybutyleneterephthalate), vinylon films, polyimide films, polyphenylenesulfide films, polyamideimide films, polysulfone films, polyetherimide films, polyethersulfone films, and polyetherketone films. In these films, there may be preferred polyethylene films, biaxially oriented polypropylene films, biaxially oriented polyamide films, biaxially oriented polyester films (poly-ethyleneterephthalate, polybutyleneterephthalate), and vinylon films, and there may particularly be preferred polyethylene films, biaxially oriented polyamide films, and biaxially oriented polyester films (polyethyleneterephthalate, polybutyleneterephthalate).

Additionally, into the base film, for example, a mold releasing agent(s) of the coating type or a mold releasing agent(s) of the kneading type may be incorporated to the extent that the gists of the second invention are not deteriorated.

Additionally, in transferring a thin film to a thermoplastic resin sheet, it is necessary to heat the sheet at a temperature higher than the glass transition temperature of a thermoplastic resin forming the sheet, and therefore, a resin forming a base film should have heat resistance higher than that of the thermoplastic resin forming the sheet. The heat resistance temperature of a base film may preferably be not lower than 80° C., more preferably not lower than 120° C., and still more preferably not lower than 150° C. When the heat resistance temperature is lower than 80° C., the base film may melt at the time of transferring, so that sufficient antistatic performance and/or ultraviolet absorption performance cannot be exhibited in some cases. Additionally, the term “heat resistance temperature” as used herein means a melting point (Tm) measured in accordance with JIS K7122, or a glass transition temperature (Tg) for films having no melting point.

The thickness of a base film may preferably be not smaller than 5 μm and not greater than 100 μm, more preferably not smaller than 10 μm and not greater than 80 μm, and still more preferably not smaller than 15 μm and not greater than 60 μm. When the thickness of a base film is smaller than 5 μm, the base film may have an insufficient strength and may be broken at the time of pressure bonding. In contrast, when the thickness of a base film is greater than 100 μm, not only the base film may become disadvantageous in costs, but also pressure bonding by rolls may become uneven, so that there may occur the irregularity of a thin film transferred.

As the organic solvent to prepare a resin mixture, it may appropriately be selected depending upon the kind of resin or additive, although it is not particularly limited. For example, there can be mentioned aromatic solvents such as benzene, toluene, xylene, and chlorobenzene; ether solvents such as 1,4-dioxane and tetrahydrofuran; ketone solvents such as methyl ethyl ketone and methyl isobutyl ketone; ester solvents such as ethyl acetate and butyl acetate; alcohol solvents such as methanol, ethanol, isopropanol, and butanol; and water. These solvents may be used alone, or two or more kinds of these solvents may also be used in combination. In these solvents, mixed solvents of an aromatic solvent(s) and an alcohol solvent(s) may particularly be preferred.

To apply a resin mixture to a base film, any of the heretofore known thin film forming methods may be used, although it is not particularly limited. For example, there can be mentioned brush coating methods, spray coating methods, roll coating methods, bar coating methods, T-die coating methods, roll reverse coating methods, applicator coating methods, spin coating methods, dip coating methods, flow coating methods, gravure coating methods, MOCVD methods, CVD methods, and sputtering methods.

As a method of drying after a resin mixture is applied to a base film, any of the heretofore known drying methods may be employed, although it is not particularly limited. For example, there can be mentioned natural drying methods, air drying methods, hot-air drying methods, and infrared radiation methods. The drying temperature is generally in a range from room temperature to about 80° C. The drying time is generally 1 minute to 24 hours.

<Production of Light Diffusion Plate>

A light diffusion plate can be produced by extruding a thermoplastic resin sheet while pressure bonding a transfer film on at least one side of the thermoplastic resin sheet to transfer a thin film to the thermoplastic resin sheet from the transfer film. In the extrusion of a thermoplastic resin sheet, any of the heretofore known sheet extruders may be employed, and in the pressure bonding of a transfer film, any of the heretofore known pressure bonding laminating machines may be employed. Additionally, it is required that in addition to the extrusion of a thermoplastic resin sheet, the pressure bonding of a transfer film is carried out, and therefore, a pressure bonding machine may be set at a place where the temperature of a thermoplastic resin forming the sheet becomes higher than the glass transition temperature thereof.

First, a thermoplastic resin forming the sheet and, if necessary, additives, are fed a sheet extruder and after sufficient kneading, are extruded in sheet form. In this time, a transfer film is pressure bonded on at least one side of the thermoplastic resin sheet extruded by a pressure bonding laminating machine provided at a place where the temperature of a thermoplastic resin forming the sheet becomes higher than the glass transition temperature thereof. Of course, the transfer film is fed to the pressure bonding laminating machine so that a thin film formed on the surface of a base film is faced to the thermoplastic resin sheet. The supply of the transfer film may be either of the batch system or of the continuous system.

To explain it in more detail, in an ordinary sheet extruder equipped with an extruder, a sheet die, polishing rolls, and take-up rolls, a pressure bonding laminating machine with heat pressure bonding rolls is provided between the polishing rolls and the take-up rolls, and a transfer film having a specific length in the case of the batch system, or a transfer film taken out from a film roll in the case of the continuous system, is allowed to pass through a film feed roll to the heat pressure bonding rolls under a tension, thereby transferring it to one side or both sides of the extruded thermoplastic resin sheet.

At this time, it is possible for distortion to be few on a transfer bonding surface and to provide uniform transferring when it is transferred under a tension of the transfer film (i.e., a tension per unit length in the width direction of rolls for feeding the transfer film) to be of not smaller than 0.01 kg/cm and not greater than 0.1 kg/cm, by pressure bonding rolls heated at a temperature of not lower than 60° C. and not higher than 200° C. under a linear pressure at a roll pressure (i.e., a roll pressure per unit length in the width direction of the rolls) of not smaller than 1 kg/cm and not greater than 10 kg/cm. When the tension of a transfer film is smaller than 0.01 kg/cm, wrinkles may occur in the transfer film. In contrast, when the tension of a transfer film is greater than 0.1 kg/cm, cracks may occur in a thin film due to the elongation of the transfer film. Also, when the temperature of heat pressure bonding rolls is lower than 60° C., the adhesion between the thermoplastic resin sheet and the thin film transferred may be low. In contrast, when the temperature of heat pressure bonding rolls is higher than 200° C., the surface of the thermoplastic resin sheet may become coarse, and undulation may become large. Further, when the roll pressure of heat pressure bonding rolls is smaller than 1 kg/cm, air may easily be sucked. In contrast, when the roll pressure of heat pressure bonding rolls is higher than 10 kg/cm, optical distortion may occur in the light diffusion plate obtained.

Additionally, when a feed roll for a transfer film is a roll of the expander roll system or the spiral roll system, it is preferred because wrinkles of a thin film at the time of pressure bonding can be prevented.

The light diffusion plate thus obtained has a thin film of at least one layer on at least one side of a thermoplastic resin sheet, at least one layer of the thin film containing an antistatic agent(s), and a base film still adheres to the thin film. This base film may be peeled off in an extrusion step or before the actual use of the light diffusion plate. Additionally, the peel strength of a base film after a thin film is transferred may preferably be not smaller than 0.02 N/cm and not greater than 1.0 N/cm. When the peel strength of a base film is in this range, it is possible to use the base film as a protective film for a thin film. The term “the peel strength of a base film” as used herein is a value measured by using a tensile tester in a 180° direction at a tensile speed of 300 mm/min.

According to the production process of the second invention, the use of a transfer method makes it possible to produce, with high efficiency, a light diffusion plate having a thin film of at least one layer on at least one side of a thermoplastic resin sheet, at least one layer of the thin film containing an antistatic agent(s), which is industrially advantageous.

### EXAMPLES

The present invention will be explained below in detail by reference to Examples, but the present invention is not limited to these Examples. The present invention can be put into practice after appropriate modifications or variations within a range meeting the gists described above and later, all of which are included in the technical scope of the present invention.

First, the evaluation and test methods for the functional thermoplastic resin sheets of the first invention will be explained.

<Thickness of Thin Film>

For a cross section of a transfer film with a thin film formed on the surface of a base film, it was sliced by a microtome to a thickness of 15 μm at arbitrary ten points to observe their cross sections with a microscope, thereby measuring the thickness of the thin film and the average at the ten points was defined as the thickness of the thin film.

<Adhesion of Thin Film>

The adhesion of a thin film to a thermoplastic resin sheet is measured in accordance with former JIS K5400 (i.e., cross-cut tape adhesion test). That is, a thin film transferred to a thermoplastic resin sheet is notched by a cutter into hundred cross cuts each having a size of 1 mm by 1 mm, and a commercially available adhesive tape (Sellotape (registered trademark), available from Nichiban Co., Ltd.) is bonded to these cross cuts, after which the adhesive tape is strongly peeled off by hand to evaluate the peeling of the thin film on the following criteria:

o: number of cross cuts peeled off is smaller than 10; and

x: number of cross cuts peeled off is not smaller than 10.

<Antistatic Property>

After a thin film is transferred to an uneven surface of a thermoplastic resin sheet, surface resistivity is measured in accordance with JIS K6911 to evaluate antistatic property on the following criteria:

o: surface resistivity is smaller than 1×10¹² Ω; and

x: surface resistivity is not smaller than 1×10¹² Ω.

<Light Resistance>

After a thin film is transferred to an uneven surface of a thermoplastic resin sheet, this sheet is irradiated, using an Eye Super UV tester (model SUV-W13, available from Iwasaki Electric Co., Ltd.), by an ultraviolet ray with an intensity of 100 mW/cm² for 50 hours, and from yellow index (YI) measured before and after the ultraviolet irradiation in accordance with JIS Z8722, ΔYI is calculated by the formula: ΔYI=yellow index (YI) after ultraviolet irradiation−yellow index (YI) before ultraviolet irradiation, to evaluate light resistance on the following criteria:

o: ΔYI≦5; and

x: ΔYI>5.

<Retention of Uneven Surface>

The appearance of a sheet transferred with a thin film using pressure bonding rolls and the appearance of a sheet not transferred with a thin film by leaving pressure bonding rolls off are compared with naked eyes visually to evaluate the retention of an uneven surface on the following criteria:

o: no large change occurs in appearance; and

x: a large change occurs in appearance.

<Overall Evaluation>

Regarding overall evaluation, of adhesion, antistatic property, light resistance, and retention of an uneven surface, “o” is when all items are “o”, whereas “x” is when at least one item is “x”.

Next, there will be explained the preparation of transfer films, the extrusion of thermoplastic resin sheets, and the transferring of thin films in the first invention.

<Preparation of Transfer Films>

Transfer Film (1-1)

As a base film, a high density polyethylene film (HS-30, available from Tamapoly Co., Ltd.; melting point of 110° C., 50 μm in thickness, 300 mm in width) was used. On one side thereof, there was coated, by a reverse roll coater, a mixture, at a solid content ratio of 1:0.2, of an acrylic resin having an ultraviolet absorption property (HALS hybrid UV-G13, available from Nippon Shokubai Co., Ltd.; ethyl acetate solution) and a quaternary ammonium salt type antistatic agent (Resistat PU-101, available from Dai-Ichi Kogyo Seiyaku Co., Ltd.), and then dried at 80° C. for 5 minutes, thereby obtaining a transfer film (1-1) having a thin film (3.5 μm in thickness) of one layer, which was made of an acrylic resin having an ultraviolet absorption property containing an antistatic agent and formed on the base film.

Transfer Film (1-2)

As a base film, a biaxially oriented polypropylene film (Torayfan 2500S, available from Toray Industries, Inc.; melting point of 165° C., 50 μm in thickness, 300 mm in width) was used. On one side thereof, there was coated, by a reverse roll coater, a mixture, at a solid content ratio of 1:0.2, of an acrylic resin having an ultraviolet absorption property (HALS hybrid UV-G13, available from Nippon Shokubai Co., Ltd.; ethyl acetate solution) and a quaternary ammonium salt type antistatic agent (Resistat PU-101, available from Dai-Ichi Kogyo Seiyaku Co., Ltd.), and then dried at 80° C. for 5 minutes, thereby obtaining a transfer film (1-2) of a thin film (3.5 μm in thickness) of one layer, which was made of an acrylic resin having an ultraviolet absorption property containing an antistatic agent and formed on the base film.

Transfer Film (1-3)

As a base film, a biaxially oriented polyethylene terephthalate film (Lumirror S10, available from Toray Industries, Inc.; melting point of 245° C., 38 μm in thickness, 300 mm in width) was used. On one side thereof, there was coated, by a reverse roll coater, a mixture, at a solid content ratio of 1:0.2, of an acrylic resin having an ultraviolet absorption property (HALS hybrid UV-G13, available from Nippon Shokubai Co., Ltd.; ethyl acetate solution) and a quaternary ammonium salt type antistatic agent (Resistat PU-101, available from Dai-Ichi Kogyo Seiyaku Co., Ltd.), and then dried at 80° C. for 5 minutes, thereby obtaining a transfer film (1-3) of a thin film (3.5 μm in thickness) of one layer, which was made of an acrylic resin having an ultraviolet absorption property containing an antistatic agent and formed on the base film.

Additionally, transfer films (1-1), (1-2), and (1-3) were prepared in film rolls by processing equipment in which a base film was fed from a take-out roll trough processing parts such as a coating part and a drying part to a take-up roll.

<Extrusion of Thermoplastic Resin Sheets>

As thermoplastic resins, there were used an acrylic resin (Delpet 70H, available from Asahi Kasei Corporation; Tg, 103° C.), an MS resin (Estyrene MS600, available from Nippon Steel Chemical Co., Ltd.; Tg, 87° C.), a PC resin (Iupilon E200OFN, available from Mitsubishi Engineering-Plastic Corporation; Tg, 143° C.), a COC resin (TOPAS 6013, available from Ticona GmbH; Tg, 140° C) , and a PS resin (PSJ polystyrene SGP 10, available from PS Japan Corporation; Tg 80° C.). Each of these resins is extruded by an ordinary method using an extruder (screw diameter, 50 mmφ; L/D=32; single screw), a gear pump, a die, a unit of three cooling rolls (i.e., mirror surface, decoration surface (emboss patterned uneven surface), and mirror surface), guide rolls, and take-up rolls, thereby obtaining a thermoplastic resin sheet having a width of 300 mm. On one side of the thermoplastic resin sheet obtained, an uneven shape was formed by the decoration surface of the second cooling roll.

Additionally, the resin temperature at the time of extrusion was adjusted as follows: 260° C. for the acrylic resin (Tg, 103° C.); 230° C. for the MS resin (Tg, 87° C.); 280° C. for the PC resin (Tg, 143° C.); 250° C. for the COC resin (Tg, 140° C.); and 170° C. for the PS resin (Tg, 80° C.). Also, the distance between the discharging outlet of the die and the cooling rolls, and the rotational speeds of the cooling rolls and the take-up rolls were adjusted so that the thickness of each sheet became 2 mm, and the extrusion speed of each sheet was 0.7 m/min.

The sheets obtained from the above thermoplastic resins have no thin film, so that all sheets had a surface resistivity of greater than 1×10¹⁶ Ω, and regarding the light resistance of each sheet, ΔYI was not smaller than 10, except the sheet made of the acrylic resin.

<Transfer of Thin Film>

Between the cooling rolls and the guide rolls, there were set a static eliminating air supplier for eliminating dust (SJ-R036, available from Keyence Corporation) and a far-infrared panel heater for heating an extruded sheet, and while keeping the surface temperature of the sheet at a specific temperature, a transfer film in roll wound form was continuously fed through a feed roll and pressure bonding rolls so that a thin film of the transfer film was faced to the uneven surface side of the extruded sheet, thereby pressure bonding the transfer sheet to the uneven surface side of the extruded sheet. Additionally, the surface temperature of the sheet was measured by using a radiation thermometer (IR-TAF, available from Chino Corporation).

Additionally, as the pressure bonding rolls, there were used those which have silicone rubber lining having a Shore hardness of Hs60 on the surface of metal rolls. Also, the pressure bonding of the transfer film was carried out under a tension of the transfer film (i.e., a tension per unit length in the width direction of the roll feeding the transfer film) of 0.03 kg/cm, at a temperature of 70° C. for the pressure bonding rolls, while pressuring under a linear pressure at a roll pressure (i.e., a roll pressure per unit length in the width direction of the rolls) of 6 kg/cm.

Next, Examples 1-1 to 1-9 of the functional thermoplastic resin sheets of the first invention and Comparative Examples 1-1 to 1-8 will be explained.

### Example 1-1

As described above, the acrylic resin was extruded in sheet form, and the transfer film (1-1) was pressure bonded thereon at a place where the surface temperature of the sheet was adjusted to 130° C., after which a base film was peeled off, thereby obtaining a functional thermoplastic resin sheet. Additionally, the degree of the uneven surface of the extruded acrylic resin sheet was 6.5 μm in center line average roughness. The evaluation results of the functional thermoplastic resin sheet are shown in Table 1.

### Example 1-2

As described above, the MS resin was extruded in sheet form, and the transfer film (1-1) was pressure bonded thereon at a place where the surface temperature of the sheet was adjusted to 120° C., after which a base film was peeled off, thereby obtaining a functional thermoplastic resin sheet. Additionally, the degree of the uneven surface of the extruded MS resin sheet was 4.8 μm in center line average roughness. The evaluation results of the functional thermoplastic resin sheet are shown in Table 1.

### Example 1-3

As described above, the PC resin was extruded in sheet form, and the transfer film (1-1) was pressure bonded thereon at a place where the surface temperature of the sheet was adjusted to 170° C., after which a base film was peeled off, thereby obtaining a functional thermoplastic resin sheet. Additionally, the degree of the uneven surface of the extruded PC resin sheet was 5.2 μm in center line average roughness. The evaluation results of the functional thermoplastic resin sheet are shown in Table 1.

### Example 1-4

As described above, the COC resin was extruded in sheet form, and the transfer film (1-1) was pressure bonded thereon at a place where the surface temperature of the sheet was adjusted to 170° C., after which a base film was peeled off, thereby obtaining a functional thermoplastic resin sheet. Additionally, the degree of the uneven surface of the extruded COC resin sheet was 6.6 μm in center line average roughness. The evaluation results of the functional thermoplastic resin sheet are shown in Table 1.

### Example 1-5

As described above, the PS resin was extruded in sheet form, and the transfer film (1-1) was pressure bonded thereon at a place where the surface temperature of the sheet was adjusted to 120° C., after which a base film was peeled off, thereby obtaining a functional thermoplastic resin sheet. Additionally, the degree of the uneven surface of the extruded PS resin sheet was 6.4 μm in center line average roughness. The evaluation results of the functional thermoplastic resin sheet are shown in Table 1.

### Example 1-6

As described above, the PC resin was extruded in sheet form, and the transfer film (1-2) was pressure bonded thereon at a place where the surface temperature of the sheet was adjusted to 200° C., after which a base film was peeled off, thereby obtaining a functional thermoplastic resin sheet. Additionally, the degree of the uneven surface of the extruded PC resin sheet was 3.8 μm in center line average roughness. The evaluation results of the functional thermoplastic resin sheet are shown in Table 1.

### Example 1-7

As described above, the COC resin was extruded in sheet form, and the transfer film (1-2) was pressure bonded thereon at a place where the surface temperature of the sheet was adjusted to 170° C., after which a base film was peeled off, thereby obtaining a functional thermoplastic resin sheet. Additionally, the degree of the uneven surface of the extruded COC resin sheet was 5.5 μm in center line average roughness. The evaluation results of the functional thermoplastic resin sheet are shown in Table 1.

### Example 1-8

As described above, the PC resin containing 0.5% by weight of spherical silica fine particles (Seahostar KE-P150, available from Nippon Shokubai Co., Ltd.; average particle diameter of 1.33 to 1.83 μm; these spherical silica fine particles act as a light diffusing agent) was extruded in sheet form, and the transfer film (1-1) was pressure bonded thereon at a place where the surface temperature of the sheet was adjusted to 200° C., after which a base film was peeled off, thereby obtaining a functional thermoplastic resin sheet (i.e., a light diffusion plate provided with surface functionality). Additionally, the degree of the uneven surface of the extruded PC resin sheet was 7.2 μm in center line average roughness. The evaluation results of the functional thermoplastic resin sheet are shown in Table 1.

### Example 1-9

As described above, the PS resin containing 0.5% by weight of spherical silica fine particles (Seahostar KE-P150, available from Nippon Shokubai Co., Ltd.; average particle diameter of 1.33 to 1.83 μm; this spherical silica fine particles act as a light diffusing agent) was extruded into a sheet, the transfer film (1-1) was pressure bonded thereon at a place where the sheet surface temperature was adjusted to 130° C., after which a base film was peeled off, thereby obtaining a functional thermoplastic resin sheet (i.e. a light diffusion plate provided with surface functionality). Additionally, the degree of the uneven surface of the extruded PS resin sheet was 6.0 μm in center line average roughness. The evaluation results of the functional thermoplastic resin sheet are shown in Table 1.

### Comparative Example 1-1

As described above, the acrylic resin was extruded in sheet from, and the transfer film (1-2) was pressure bonded thereon at a place where the surface temperature of the sheet was adjusted to 130° C., after which a base film was peeled off, thereby obtaining a functional thermoplastic resin sheet. Additionally, the degree of the uneven surface of the extruded acrylic resin sheet was 5.4 μm in center line average roughness. The evaluation results of the functional thermoplastic resin sheet are shown in Table 1.

### Comparative Example 1-2

As described above, the MS resin was extruded in sheet form, and the transfer film (1-2) was pressure bonded thereon at a place where the surface temperature of the sheet was adjusted to 120° C., after which a base film was peeled off, thereby obtaining a functional thermoplastic resin sheet. Additionally, the degree of the uneven surface of the extruded MS resin sheet was 6.5 μm in center line average roughness. The evaluation results of the functional thermoplastic resin sheet are shown in Table 1.

### Comparative Example 1-3

As described above, the MS resin was extruded in sheet form, and the transfer film (1-2) was pressure bonded thereon at a place where the surface temperature of the sheet was adjusted to 180° C., after which a base film was peeled off, thereby obtaining a functional thermoplastic resin sheet. Additionally, the degree of the uneven surface of the extruded MS resin sheet was 7.1 μm in center line average roughness. The evaluation results of the functional thermoplastic resin sheet are shown in Table 1.

### Comparative Example 1-4

As described above, the PC resin was extruded in sheet form, and the transfer film (1-3) was pressure bonded thereon at a place where the surface temperature of the sheet was adjusted to 180° C., after which a base film was peeled off, thereby obtaining a functional thermoplastic resin sheet. Additionally, the degree of the uneven surface of the extruded PC resin sheet was 6.0 μm in center line average roughness. The evaluation results of the functional thermoplastic resin sheet are shown in Table 1.

### Comparative Example 1-5

As described above, the acrylic resin was extruded in sheet form, and the transfer film (1-1) was pressure bonded thereon at a place where the surface temperature of the sheet was adjusted to 80° C., after which a base film was peeled off, thereby obtaining a functional thermoplastic resin sheet. Additionally, the degree of the uneven surface of the extruded acrylic resin sheet was 3.8 μm in center line average roughness. The evaluation results of the functional thermoplastic resin sheet are shown in Table 1.

### Comparative Example 1-6

As described above, the PC resin was extruded in sheet form, and the transfer film (1-1) was pressure bonded thereon at a place where the surface temperature of the sheet was adjusted to 100° C., after which a base film was peeled off, thereby obtaining a functional thermoplastic resin sheet. Additionally, the degree of the uneven surface of the extruded PC resin sheet was 5.5 μm in center line average roughness. The evaluation results of the functional thermoplastic resin sheet are shown in Table 1.

### Comparative Example 1-7

As described above, the PS resin was extruded in sheet form, and the transfer film (1-3) was pressure bonded thereon at a place where the surface temperature of the sheet was adjusted to 180° C., after which a base film was peeled off, thereby obtaining a functional thermoplastic resin sheet. Additionally, the degree of the uneven surface of the extruded PS resin sheet was 6.3 μm in center line average roughness. The evaluation results of the functional thermoplastic resin sheet are shown in Table 1.

### Comparative Example 1-8

As described above, the PC resin was extruded in sheet form, and the transfer film (1-2) was pressure bonded thereon at a place where the surface temperature of the sheet was adjusted to 150° C., after which a base film was peeled off, thereby obtaining a functional thermoplastic resin sheet. Additionally, the degree of the uneven surface of the extrusion molded PC resin sheet was 6.6 μm in center line average roughness. The evaluation results of the functional thermoplastic resin sheet are shown in Table 1.

TABLE 1

| | | Surface temperature of | | | | | |
|---|---|---|---|---|---|---|---|
| | | sheet at the time of | | | | | |
| | | transferring | | Antistatic | Light | | |
| | Thermoplastic | (° C.) | Adhesion of | property | resistance | | |
| | resin | Melting point of base film | thin film | (Ω) | (ΔYI) | Retention of | Overall |
| | Transfer film | (° C.) | Evaluation | Evaluation | Evaluation | uneven surface | evaluation |
| Example 1-1 | Acrylic resin | 130 (Tg + 27) | 100/100 | 2.7 × 10⁹ | 1.5 | ◯ | ◯ |
| | (1-1) | 110 | ◯ | ◯ | ◯ | | |
| Example 1-2 | MS resin | 120 (Tg + 33) | 98/100 | 3.5 × 10⁹ | 3.5 | ◯ | ◯ |
| | (1-1) | 110 | ◯ | ◯ | ◯ | | |
| Example 1-3 | PC resin | 170 (Tg + 27) | 100/100 | 2.2 × 10⁹ | 1.8 | ◯ | ◯ |
| | (1-1) | 110 | ◯ | ◯ | ◯ | | |
| Example 1-4 | COC resin | 170 (Tg + 30) | 95/100 | 3.7 × 10⁹ | 1.0 | ◯ | ◯ |
| | (1-1) | 110 | ◯ | ◯ | ◯ | | |
| Example 1-5 | PS resin | 120 (Tg + 40) | 99/100 | 4.2 × 10⁹ | 3.5 | ◯ | ◯ |
| | (1-1) | 110 | ◯ | ◯ | ◯ | | |
| Example 1-6 | PC resin | 200 (Tg + 57) | 100/100 | 7.2 × 10¹⁰ | 2.2 | ◯ | ◯ |
| | (1-2) | 165 | ◯ | ◯ | ◯ | | |
| Example 1-7 | COC resin | 170 (Tg + 30) | 93/100 | 3.0 × 10¹¹ | 1.3 | ◯ | ◯ |
| | (1-2) | 165 | ◯ | ◯ | ◯ | | |
| Example 1-8 | PC resin | 200 (Tg + 57) | 100/100 | 3.7 × 10¹⁰ | 3.2 | ◯ | ◯ |
| | (1-1) | 110 | ◯ | ◯ | ◯ | | |
| Example 1-9 | PS resin | 130 (Tg + 37) | 98/100 | 4.8 × 10¹⁰ | 2.8 | ◯ | ◯ |
| | (1-1) | 110 | ◯ | ◯ | ◯ | | |
| Comp. Ex. 1-1 | Acrylic resin | 130 (Tg + 27) | — | 6.1 × 10¹⁵ | 3.2 | ◯ | X |
| | (1-2) | 165 | — | X | ◯ | | |
| Comp. Ex. 1-2 | MS resin | 120 (Tg + 33) | — | 7.1 × 10¹⁶ | 10.4 | ◯ | X |
| | (1-2) | 165 | — | X | X | | |
| Comp. Ex. 1-3 | MS resin | 180 (Tg + 93) | 100/100 | 4.5 × 10¹¹ | 3.7 | X | X |
| | (1-2) | 165 | ◯ | ◯ | ◯ | | |
| Comp. Ex. 1-4 | PC resin | 180 (Tg + 37) | — | 3.8 × 10¹⁴ | 7.5 | ◯ | X |
| | (1-3) | 245 | — | X | X | | |
| Comp. Ex. 1-5 | Acrylic resin | 80 (Tg − 23) | — | 9.6 × 10¹⁵ | 4.3 | ◯ | X |
| | (1-1) | 110 | — | X | ◯ | | |
| Comp. Ex. 1-6 | COC resin | 100 (Tg − 40) | — | 5.0 × 10¹⁶ | 2.8 | ◯ | X |
| | (1-1) | 110 | — | X | ◯ | | |
| Comp. Ex. 1-7 | PS resin | 180 | 99/100 | 5.3 × 10⁹ | 3.6 | X | X |
| | (1-3) | 245 | ◯ | ◯ | ◯ | | |
| Comp. Ex. 1-8 | PC resin | 150 (Tg + 7) | — | 2.4 × 10¹⁶ | 12.4 | ◯ | X |
| | (1-2) | 165 | — | X | X | | |

* in Table 1, the symbol “—” means that no evaluation of the adhesion of the thin film was carried out because at least one item of “antistatic property”, “light resistance”, and “retention of uneven surface” was “X”.

As can be seen from Table 1, the functional thermoplastic resin sheets of Examples 1-1 to 1-9 meet the conditions that when the glass transition temperature of each sheet is denoted as Tg, the surface temperature of each sheet at the time of transferring is in a range of not lower than (Tg−10° C.) and not higher than (Tg+70° C.) and the softening point (or the melting point) of the base film is lower than the surface temperature of each sheet at the time of transferring, so that all items of “adhesion of thin film”, “antistatic property”, “light resistance”, and “retention of uneven surface” were excellent to have the overall evaluation of “o”.

In contrast, the functional thermoplastic resin sheets of Comparative Examples 1-1 to 1-8 fail to meet the above conditions, so that at least one item of “antistatic property”, “light resistance”, and “retention of uneven surface” was deteriorated to have the overall evaluation of “x”.

Thus, it is understood that functional thermoplastic resin sheets, each of which is excellent in the adhesion of a thin film and the retention of an uneven surface, can be obtained when the transferring of a thin film is carried out so that the above conditions are met, even in the case of thermoplastic resin sheets each having an uneven surface, regardless of the kind of thermoplastic resin forming each sheet.

Next, the evaluation and test methods for the light diffusion plates of the second invention will be explained.

<Thickness of Thin Film>

For a cross section of a transfer film with a thin film formed on the surface of a base film, it was sliced by a microtome to a thickness of 15 μm at arbitrary ten points to observe their cross sections with a microscope, thereby measuring the thickness of the thin film and the average at the ten points was defined as the thickness of the thin film.

<Antistatic Property>

The antistatic property of light diffusion plates was evaluated by measuring the surface resistivity on a thin film side containing an antistatic agent(s). Additionally, the surface resistivity was measured in such a manner that a measuring sample was allowed to stand under an atmosphere at a temperature of 23° C. and a humidity of 60% RH for 24 hours, and then it is measured for surface resistivity using a high resistance meter (HP 4339A, available from Hewlett-Packard Company) and a sensor (16008, available from Hewlett-Packard Company). The measuring voltage was 250 V and the charge time was 60 seconds.

<Brightness>

The brightness of light passing through light diffusion plates was measured by using a brightness tester (model BM-7, available from Topcon Corporation) The atmosphere of a measurement room was set at a temperature of 25° C. and a humidity of 60% RH, and a measuring sample of 231 mm in length and 321 mm in width was installed in a direct type backlight unit (the lamp intensity was set for cold cathode tube lamps to be 10,000 cd/m²) for 15 inch liquid crystal display devices. The brightnesses (cd/m²) at nine points of the measuring sample were measured, of which average was defined as the brightness. Additionally, the places for measuring the brightness were total nine points consisting of a center point of each light diffusion plate, two points of 77 mm apart from the center above and below in the longitudinal direction, six points of 107 mm apart from these three points right and left in the transverse direction. The measurement distance was 50 cm and the viewing angle was 1°.

<Accelerated Light Resistance Test>

After each light diffusion plate was irradiated by an ultraviolet ray for a long time, the brightness of light passing through the light diffusion plate was measured for evaluation in the same manner as described above, together with the evaluation of the antistatic property of the light diffusion plate. Additionally, the ultraviolet ray was irradiated by using ultraviolet irradiation equipment (Eye Super Tester model W14, available from Iwasaki Electric Co., Ltd.) at 63° C. for 20 hours. The radiation strength of the ultraviolet ray was 100 mW/cm².

<Peel Strength>

The peel strength of a base film was evaluated by measuring a force required to cause peeling between the base film and the thin film in such a manner that each light diffusion plate was cut to a piece of 150 mm in length and 25 mm in width, and the piece was allowed to stand at 23° C. and 50% RH for 30 minutes, after which using a tensile tester (product name, QC tensile tester, available from Tester Sangyo Co., Ltd.), one end of the base film (i.e., one end in the longitudinal direction) was pulled in the 180° direction at a speed of 300 mm/min to cause peeling. Additionally, the peel strength is expressed in N/cm.

Next, Examples 2-1 to 2-9 of the second invention and Comparative Examples 2-1 to 2-5 will be explained.

### Example 2-1

<Preparation of Transfer Film>

To 1,000 parts of a mixed solvent of toluene/isopropyl alcohol (weight ratio, 70/30), there were added 45 parts of a copolymer of methyl methacrylate containing 20 wt % of an ammonium salt structure shown by the following formula: 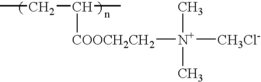
as an antistatic agent, and 5.0 parts of an ultraviolet absorbing agent (Tinubin 329, available from Chiba Specialty Chemicals Corporation; benzotriazole type) to give a mixture. The mixture was applied by a roll reverse coater to a biaxially oriented polyethylene terephthalate film (Toyobo ester film, available from Toyobo Co., Ltd.; 38 μm in thickness, 600 mm in width) as a base film, and dried at 80° C. for 5 minutes to give a transfer film with a thin film (3 μm in thickness) of one layer made of an acrylic type resin containing an antistatic agent and an ultraviolet absorbing agent formed on the base film.

<Production of Light Diffusion Plate>

Then, 100% by weight of a polycarbonate type resin (Iupilon E2000OFN, available from Mitsubishi Engineering-Plastic Corporation), 0.5% by weight of silica particles (Seahostar KE-P150, available from Nippon Shokubai Co., Ltd.; average particle diameter, 1.5 μm), 0.05% by weight of an antioxidant (Irganox 2215, available from Chiba Specialty Chemicals Corporation; phenol, phosphoric acid, and lactone mixed type), and 0.003% by weight of a fluorescent whitener (Uvitex OB, available from Chiba Specialty Chemicals Corporation; oxazole type) were fed to a sheet extruder equipped with a vent, a gear pump, three rolls, or a two roll pressure bonding laminating machine to extrude a sheet at a formation temperature of 280° C. The two roll pressure bonding laminating machine was set at a place where the resin temperature of the polycarbonate type resin was higher than the glass transition temperature thereof, the thermoplastic resin sheet and the transfer film were pressure bonded so that the thin film formed on the surface of the transfer film was faced to one side of the thermoplastic resin sheet to give a light diffusion plate (2 mm in thickness) with a thin film of one layer containing an antistatic agent and an ultraviolet absorbing agent formed on one side of the thermoplastic resin sheet.

<Evaluation of Light Diffusion Plate>

The antistatic property on the thin film side of the light diffusion plate obtained was evaluated to find that the surface resistivity was 6×10⁹ Ω, indicating an excellent antistatic property. The brightness of light passing through the light diffusion plate was measured to find that it was 3,850 cd/m² after the transferring of the thin film, whereas it was 4,000 cd/m² before the transferring of the thin film, and the decreasing rate of brightness due to the transferring of the thin filmwas 3.75%. Also, after the accelerated light resistance test was carried out, the antistatic property on the thin film side of the light diffusion plate was evaluated to find that the surface resistivity was 4×10¹¹ Ω, indicating a still excellent antistatic property, and no deterioration due to light was observed. Also, the brightness of light passing through the light diffusion plate was measured to find that it was 3,600 cd/m², and the deceasing rate was 6.49%, indicating a small reduction of brightness, and no deterioration due to light was observed. In this way, the light diffusion plate of the present Example showed an antistatic property and a light resistance. Further, the peel strength of the base film after the thin film was transferred was 0.5 N/cm, which made it possible to use as a protective film for the light diffusion plate.

### Example 2-2

### Preparation of Transfer Film

To 1,000 parts of a mixed solvent of toluene/isopropyl alcohol (weight ratio, 70/30), there were added 46.75 parts of an acrylic type resin (Sumipex EXA, available from Sumitomo Chemical Co., Ltd.; reflective index, 1.49), 0.75% by weight of tetrabutylammonium chloride as an antistatic agent, and 2.5% by weight of an ultraviolet absorbing agent (Tinubin 1577, available from Chiba Specialty Chemicals Corporation; triazine type) to give a mixture. The mixture was applied by a roll reverse coater to a biaxially oriented polyethylene terephthalate film (Toyobo ester film, available from Toyobo Co., Ltd.; 38 μm in thickness, 600 mm in width) as a base film, and dried at 80° C. for 5 minutes to give a transfer film with a thin film (4 μm in thickness) of one layer made of an acrylic type resin containing an antistatic agent and an ultraviolet absorbing agent formed on the base film.

<Production of Light Diffusion Plate>

A light diffusion plate (2 mm in thickness) with a thin film of one layer containing an antistatic agent and an ultraviolet absorbing agent formed on one side of a thermoplastic resin sheet was obtained in the same manner as described in Example 1, except that the transfer film obtained above was used.

<Evaluation of Light Diffusion Plate>

The antistatic property on the thin film side of the light diffusion plate obtained was evaluated to find that the surface resistivity was 2×10¹² Ω, indicating an excellent antistatic property. The brightness of light passing through the light diffusion plate was measured to find that it was 3,800 cd/m² after the transferring of the thin film, whereas it was 4,000 cd/m² before the transferring of the thin film, and the decreasing rate of brightness due to the transferring of the thin film was 5%. Also, after the accelerated light resistance test was carried out, the antistatic property on thin film side of the light diffusion plate was evaluated to find that the surface resistivity was 8×10¹³ Ω, indicating a still excellent antistatic property, and no deterioration due to light was observed. Also, the brightness of light passing through the light diffusion plate was measured to find that it was 3,550 cd/m², and the decreasing rate was 6.58%, indicating a small reduction of brightness and no deterioration due to light was observed. In this way, the light diffusion plate of the present Example showed an antistatic property and a light resistance. Further, the peel strength of the base film after the thin film was transferred was 0.4 N/cm, which made it possible to use as a protective film for the light diffusion plate.

### Example 2-3

<Preparation of Transfer Film>

To a toluene solution containing 10% by weight of an acrylic type resin (Sumipex EXA, available from Sumitomo Chemical Co., Ltd.; reflective index, 1.49), there was added 0.5% by weight of an ultraviolet absorbing agent (Tomisorb 800, available from API Corporation; benzophenone type) to give a mixture. The mixture was applied by a roll reverse coater to a biaxially oriented polyethylene terephthalate film (Toyobo ester film, available from Toyobo Co., Ltd.; 38 μm in thickness, 600 mm in width) as a base film, and dried at 80° C. for 5 minutes to give a transfer film with a thin film (1 μm in thickness) of one layer containing an ultraviolet absorbing agent formed on the base film.

Next, to 1,000 parts of toluene/isopropyl alcohol (weight ratio, 70/30), there were added 50 parts of a copolymer of methyl methacrylate containing 15 wt % of a vinylbenzyl type ammonium salt shown by the following formula: 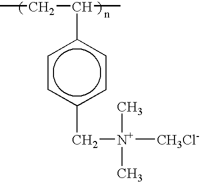
as an antistatic agent, and 0.3 parts of a fluorescent whitener (Uvitex OB, available from Chiba Specialty Chemicals Corporation; oxazole type) to give a mixture. The mixture was applied by a roll reverse coater to the thin film of the transfer film having the thin film of one layer containing an ultraviolet absorbing agent, and dried at 80° C. for 5 minutes to give a transfer film with a thin film (3 μm in thickness) containing a fluorescent whitener formed on the base film, on which a thin film (1 μm in thickness) of one layer containing an antistatic agent and an ultraviolet absorbing agent was formed.

<Production of Light Diffusion Plate>

A light diffusion plate (2 μm in thickness) with a thin film of one layer containing an antistatic agent and a fluorescent whitener formed on one side of a thermoplastic resin sheet, on which a thin film of one layer containing an ultraviolet absorbing agent was formed, was obtained in the same manner as described in Example 1, except that the transfer film obtained above was used.

<Evaluation of Light Diffusion Plate>

The antistatic property on the thin film side of the light diffusion plate obtained was evaluated to find that the surface resistivity was 4×10¹⁰ Ω, indicating an excellent antistatic property. The brightness of light passing through the light diffusion plate was measured to find that it was 4,200 cd/m² after the transferring of the thin film, whereas it was 4,000 cd/m² before the transferring of the thin film, and the decreasing rate of brightness due to the transferring of the thin film was −5%. Also, after the accelerated light resistance test was carried out, the antistatic property on the thin film side of the light diffusion plate was evaluated to find that the surface resistivity was 5×10¹² Ω, indicating a still excellent antistatic property, and no deterioration due to light was observed. Also, the brightness of light passing through the light diffusion plate was measured to find that it was 4,000 cd/m², and the decreasing rate was 4.8%, indicating a small reduction of brightness, and no deterioration due to light was observed. In this way, the light diffusion plate of the present Example showed an antistatic property and a light resistance. Further, the peel strength of the base film after the thin film was transferred was 0.5 N/cm, which made it possible to use as a protective film for the light diffusion plate.

### Example 2-4

<Preparation of Transfer Film>

To 1,000 parts of a mixed solvent of toluene/isopropyl alcohol (weight ratio, 70/30), there were added 120 parts of an acrylic type resin solution having an ultraviolet absorption property (UWR UV-G714, available from Nippon Shokubai Co., Ltd.; solid content, 40%; solvent, methyl ethyl ketone) and 1.5 parts of sodium dodecylbenzenesulfonate as an antistatic agent to give a mixture. The mixture was applied by a roll reverse coater to a biaxially oriented polyethylene terephthalate film (Toyobo ester film, available from Toyobo Co., Ltd.; 38 μm in thickness, 600 mm in width) as a base film, and dried at 80° C. for 5 minutes to give a transfer film with a thin film (3 μm in thickness) of one layer made of an acrylic type resin having an ultraviolet absorption property containing an antistatic agent formed on the base film.

<Production of Light Diffusion Plate>

A light diffusion plate (3 mm in thickness) with a thin film of one layer having an ultraviolet absorption property containing an antistatic agent formed on one side of a thermoplastic resin sheet was obtained in the same manner as described in Example 1, except that the transfer film obtained above was used.

<Evaluation of Light Diffusion Plate>

The antistatic property on the thin film side of the light diffusion plate obtained was evaluated to find that the surface resistivity was 2×10¹¹ Ω, indicating an excellent antistatic property. The brightness of light passing through the light diffusion plate was measured to find that it was 3,500 cd/m² after the transferring of the thin film, whereas it was 3,500 cd/m² before the transferring of the thin film, and the decreasing rate of brightness due to the transferring of the thin film was 0%. Also, after the accelerated light resistance test was carried out, the antistatic property on the thin film side of the light diffusion plate was evaluated to find that the surface resistivity was 2×10¹³ Ω, indicating a still excellent antistatic property, and no deterioration due to light was observed. Also, the brightness of light passing through the light diffusion plate was measured to find that it was 3,375 cd/m², and the decreasing rate was 3.6%, indicating a small reduction of brightness, and no deterioration due to light was observed. In this way, the light diffusion plate of the present Example showed an antistatic property and a light resistance. Further, the peel strength of the base film after the thin film was transferred was 0.4 N/cm, which made it possible to use as a protective film for the light diffusion plate.

### Example 2-5

<Preparation of Transfer Film>

To 100 parts of an acrylic type resin having an ultraviolet absorption property (HALS hybrid UV-G301, available from Nippon Shokubai Co., Ltd.; solid content, 43%; solvent, ethyl acetate), there were added 340 parts of ethyl acetate and 13 parts of an antistatic agent of the quaternary ammonium salt type (Resistat PU-101, available from Dai-Ichi Kogyo Seiyaku CO., Ltd.) to give a mixture. The mixture was applied by a roll reverse coater to a biaxially oriented polyethylene terephthalate film (Toyobo ester film, available from Toyobo Co., Ltd.; 38 μm in thickness, 600 mm in width) as a base film, and dried at 80° C. for 5 minutes to give a transfer film with a thin film (3 μm in thickness) of one layer made of an acrylic type resin having an ultraviolet absorption property containing an antistatic agent formed on the base film.

<Production of Light Diffusion Plate>

A light diffusion plate (3 mm in thickness) with a thin film of one layer having an ultraviolet absorption property containing an antistatic agent formed on one side of a thermoplastic resin sheet was obtained in the same manner as described in Example 1, except that the transfer film obtained above was used.

<Evaluation of Light Diffusion Plate>

The antistatic property on the thin film side of the light diffusion plate obtained was evaluated to find that the surface resistivity was 6×10¹⁰ Ω, indicating an excellent antistatic property. The brightness of light passing through the light diffusion plate was measured to find that it was 3,600 cd/m² after the transferring of the thin film, whereas it was 3,600 cd/m² before the transferring of the thin film, and the decreasing rate of brightness due to the transferring of the thin film was 0%. Also, after the accelerated light resistance test was carried out, the antistatic property on the thin film side of the light diffusion plate was evaluated to find that the surface resistivity was 2×10¹³ Ω, indicating a still excellent in antistatic property, and no deterioration due to light was observed. Also, the brightness of light passing through the light diffusion plate was measured to find that it was 3,475 cd/m², and the reducing rate was 3.5%, indicating a small reduction of brightness, and no deterioration due to light was observed. In this way, the light diffusion plate of the present Example showed an antistatic property and a light resistance. Further, the peel strength of the base film after the thin film was transferred was 0.5 N/cm, which made it possible to use as a protective film for the light diffusion plate.

### Example 2-6

<Preparation of Transfer Film>

To 1,000 parts of toluene/isopropyl alcohol (weight ratio, 70/30), there were added 50 parts of an acrylic type resin (Sumipex EXA, available from Sumitomo Chemical Co., Ltd.; reflective index, 1.49), 4.0 parts of quaternary ammonium sulfate (cationic surfactant) shown by the following formula: 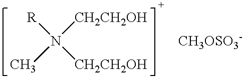
wherein R is a linear aliphatic alkyl group having from 11 to 17 carbon atoms as an antistatic agent, and 4 parts of transparent acrylic type spherical particles (Epostar MA1006, available from Nippon Shokubai Co., Ltd.; average particle diameter, 6 μm) as fine particles to give a mixture. The mixture was applied by a roll reverse coater to a biaxially oriented polyethylene terephthalate film (Toyobo ester film, available from Toyobo Co., Ltd., 40 μm in thickness, 600 mm in width) as a base film, and dried at 80° C. for 5 minutes to give a transfer film (1) with a thin film (10 μm in thickness) of one layer containing an antistatic agent and fine particles formed on the base film.

Next, to 1,000 parts of toluene/isopropyl alcohol (weight ratio, 70/30), there were added 120 parts of an acrylic type resin having an ultraviolet absorption property (UWR UV-G714, available from Nippon Shokubai Co., Ltd.; solid content, 40%; solvent, methyl ethyl ketone), and 1.5 parts of sodium dodecylbenzene-sulfonate (anionic surfactant) as an antistatic agent. The solution was applied by a roll reverse coater to a biaxially oriented polyethylene terephthalate film (Toyobo ester film, available from Toyobo Co., Ltd.; 38 μm in thickness, 600 mm in width) as a base film, and dried at 80° C. for 5 minutes to give a transfer film (2) with a thin film (3 μm in thickness) of one layer made of an acrylic type resin having an ultraviolet absorption property containing an antistatic agent formed on the base film.

<Production of Light Diffusion Plate>

A light diffusion plate (2 mm in thickness) with a thin film (1) of one layer containing an antistatic agent and fine particles on one side of a thermoplastic resin sheet and a thin film (2) of one layer having an ultraviolet absorption property containing an antistatic agent on another side of the thermoplastic resin sheet was obtained in the same manner as described in Example 1, except that the transfer films (1) and (2) obtained above were loaded to a two roll pressure bonding laminating machine and each pressure bonded on both sides of an extruded thermoplastic resin sheet.

<Evaluation of Light Diffusion Plate>

The antistatic property on the thin film side of the light diffusion plate obtained was evaluated to find that the surface resistivity was 9×10¹⁰ Ω for the thin film (1) side and 2×10¹¹ Ω for the thin film (2) side, indicating an excellent antistatic property. The brightness of light passing through the light diffusion plate was measured to find that it was 4,100 cd/m² after the transferring of the thin film, whereas it was 4,000 cd/m² before the transferring of the thin film, and the decreasing rate of brightness due to the transferring of the thin film was −2.5%. Also, after the accelerated light resistance test was carried out on the thin film (2) side, the antistatic property on the thin film side of the light diffusion plate was evaluated to find that the surface resistivity was 2×10¹³ Ω for the thin film (2) side, indicating a still excellent antistatic property, and no deterioration due to light was observed. Also, the brightness of light passing through the light diffusion plate was measured to find that it was 3,950 cd/m², and the decreasing rate was 3.7%, indicating a small reduction of brightness, and no deterioration due to light was observed. In this way, the light diffusion plate of the present Example showed an antistatic property and a light resistance. Further, the peel strength of the base film after the thin film was transferred was 0.1 N/cm for the film (1) side and 0.4 N/cm for the film (2) side, which made it possible to use as a protective film for the light diffusion plate.

### Example 2-7

<Preparation of Transfer Film>

To 1,000 parts of a mixed solvent of toluene/isopropyl alcohol (weight ratio, 70/30) , there were added 49.5 parts of an acrylic type resin (Sumipex EXA, available from Sumitomo Chemical Co., Ltd.; reflective index, 1.49), and 0.5 parts of sodium stearylsulfonate as an antistatic agent to give a mixture. The mixture was applied by a roll reverse coater to a biaxially oriented polyethylene terephthalate film (Toyobo ester film, available from Toyobo Co., Ltd.; 38 μm in thickness, 600 mm in width) as a base film, and dried at 80° C. for 5 minutes to give a transfer film with a thin film (1 μm in thickness) of one layer made of an acrylic type resin containing an antistatic agent formed on the base film.

<Production of Light Diffusion Plate>

A light diffusion plate (1 mm in thickness) with a thin film of one layer containing an antistatic agent on one side of a thermoplastic resin sheet was obtained in the same manner as described in Example 1, except that the transfer film obtained above was used.

<Evaluation of Light Diffusion Plate>

The antistatic property on the thin film side of the light diffusion plate obtained was evaluated to find that the surface resistivity was 3×10¹⁰ Ω, indicating an excellent antistatic property. The brightness of light passing through the light diffusion plate was measured to find that it was 4,610 cd/m² after the transferring of the thin film, whereas it was 4,500 cd/m² before the transferring of the thin film, and the decreasing rate of brightness due to the transferring of the thin film was 2.4%. In this way, the light diffusion plate of the present Example showed an antistatic property. Further, the peel strength of the base film after the thin film was transferred was 0.5 N/cm, which made it possible to use as a protective film for the light diffusion plate.

### Example 2-8

### <Preparation of Transfer Film>

To 1,000 parts of toluene, there were added 100 parts of an acrylic type resin (Sumipex EXA, available from Sumitomo Chemical Co., Ltd.; reflective index, 1.49) and 5.0% by weight of an ultraviolet absorbing agent (Seesorb 202, available from Shipuro Kasei Kaisha, Ltd., salicylic acid phenyl ester type) to give a mixture. The mixture was applied by a roll reverse coater to a biaxially oriented polyethylene terephthalate film (Toyobo ester film, available from Toyobo Co., Ltd.; 38 μm in thickness, 600 mm in width) as a base film, and dried at 80° C. for 5 minutes to give a transfer film with a thin film (0.5 μm in thickness) of one layer containing an ultraviolet absorbing agent formed on the base film.

Next, to 1,000 parts of a mixed solvent of toluene/isopropyl alcohol (weight ratio, 70/30), there were added 100 parts of an acrylic type resin (Sumipex EXA, available from Sumitomo Chemical Co., Ltd.; reflective index, 1.49) and 2.5 parts of an alkylimidazoline derivative as an antistatic agent (Amphitol 20Y13, available from NOF Corporation; 2-alkyl-N-carboxymethyl-N-hydroxyethylimidazolinium betaine) to give a mixture. The mixture was applied by a roll reverse coater to the thin film of the transfer film with the thin film of one layer containing an ultraviolet absorbing agent, and dried at 80° C. for 5 minutes to give a transfer film with a thin film (0.5 μm in thickness) of one layer containing an ultraviolet absorbing agent formed on the base film, on which a thin film (3 μm in thickness) of one layer containing an antistatic agent was formed.

<Production of Light Diffusion Plate>

A light diffusion plate (2 mm in thickness) with a thin film of one layer containing an antistatic agent on one side of a thermoplastic resin sheet, on which a thin film of one layer containing an ultraviolet absorbing agent was formed, was obtained in the same manner as described in Example 1, except that the transfer film obtained above was used.

<Evaluation of Light Diffusion Plate>

The antistatic property on the thin film side of the light diffusion plate obtained was evaluated to find that the surface resistivity was 5×10¹⁰ Ω, indicating an excellent antistatic property. The brightness of light passing through the light diffusion plate was measured to find that it was 4,050 cd/m² after the transferring of the thin film, whereas it was 4,000 cd/m² before the transferring of the thin film, and the decreasing rate of brightness due to the transferring of the thin film was 1.25%. Also, after the accelerated light resistance test was carried out, the antistatic property on the thin film side of the light diffusion plate was evaluated to find that the surface resistivity was 2×10¹² Ω, indicating a still excellent antistatic property, and no deterioration due to light was observed. Also, the brightness of light passing through the light diffusion plate was measured to find that it was 3,900 cd/m², the decreasing rate was 3.7%, indicating a small reduction of brightness, and no deterioration due to light was observed. In this way, the light diffusion plate of the present Example showed an antistatic property and a light resistance. Further, the peel strength of the base film after the thin film was transferred was 0.5 N/cm, which made it possible to use as a protective film for the light diffusion plate.

### Example 2-9

<Preparation of Transfer Film>

To 1,000 parts of a mixed solvent of toluene/isopropyl alcohol (weight ratio, 70/30), there were added 120 parts of an acrylic type resin solution having an ultraviolet absorption property (UWR UV-G714, available from Nippon Shokubai Co., Ltd.; solid content, 40%; solvent, methyl ethyl ketone) and 1.5 parts of sodium dodecylbenzenesulfonate as an antistatic agent to give a mixture. The mixture was applied by a roll reverse coater to a biaxially oriented polyethylene terephthalate film (Toyobo ester film, available from Toyobo Co., Ltd.; 38 μm in thickness, 600 mm in width) as a base film, and dried at 80° C. for 10 minutes to give a transfer film (1) with a thin film (1 μm in thickness) of one layer made of an acrylic type resin having an ultraviolet absorption property containing an antistatic agent formed on the base film.

Next, to a toluene/ethyl acetate (weight ratio, 70/30) solution containing 100% by weight of an acrylic type resin (Sumipex EXA, available from Sumitomo Chemical Co., Ltd.; reflective index 1.49), there were added 1.5% by weight of a copolymer of methyl methacrylate containing 15 wt % of a vinylbenzyl type ammonium salt shown by the following formula: 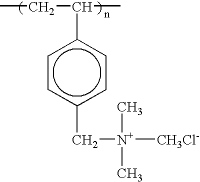
as an antistatic agent and 0.3% by weight of a fluorescent whitener (Uvitex OB, available from Chiba Specialty Chemicals Corporation; oxazole type) to give a mixture. The mixture was applied by a roll reverse coater to a biaxially oriented polyethylene terephthalate film (Toyobo ester film, available from Toyobo Co., Ltd.; 38 μm in thickness, 600 mm in width) as a base film, and dried at 80° C. for 5 minutes to give a transfer film (2) with a thin film (1 μm in thickness) of one layer containing an antistatic agent and a fluorescent whitener on the base film.

<Production of Light Diffusion Plate>

A light diffusion plate (2 mm in thickness) with a thin film (1) of one layer having an ultraviolet absorption property containing an antistatic agent on one side of a thermoplastic resin sheet and a thin film (2) of one layer containing an antistatic agent and a fluorescent whitener on another side of the thermoplastic resin sheet was obtained in the same manner as described in Example 1, except that the transfer films (1) and (2) obtained above were loaded to a two roll pressure bonding laminating machine and each pressure bonded on both sides of an extruded thermoplastic resin sheet.

<Evaluation of Light Diffusion Plate>

The antistatic property on thin film side of the light diffusion plate obtained was evaluated to find that the surface resistivity was 2×10¹¹ Ω for the thin film (1) side and 4×10¹⁰ Ω for the thin film (2) side, indicating an excellent antistatic property. The brightness of light passing through the light diffusion plate was measured to find that it was 4,100 cd/m² after the transferring of the thin film, whereas it was 4,000 cd/m² before the transferring of the thin film, and the decreasing rate of brightness due to the transferring of the thin film was −2.5%. Also, after the accelerated light resistance test was carried out on the thin film (1) side, the antistatic property on thin film side of the light diffusion plate was evaluated to find that the surface resistivity was 2×10¹¹ Ω for the thin film (1) side, indicating a still excellent antistatic property, and no deterioration due to light was observed. Also, the brightness of light passing through the light diffusion plate was measured to find that it was 3,950 cd/m², and the decreasing rate was 3.7%, indicating a small reduction of brightness, and no deterioration due to light was observed. In this way, the light diffusion plate of the present Example showed an antistatic property and a light resistance. Further, the peel strength of the base film after the thin film was transferred was 0.1 N/cm for the film (1) side and 0.4 N/cm for the film (2) side, which made it possible to use as a protective film for the light diffusion plate.

### Comparative Example 2-1

A light diffusion plate with no thin film was produced in the same manner as described in Example 1, except that no transfer film was used. The surface resistivity of the light diffusion plate obtained was 5×10¹⁷ Ω, indicating no antistatic property.

### Comparative Example 2-2

A light diffusion plate with a thin film of one layer having no antistatic agent on one side of a thermoplastic resin sheet was produced in the same manner as described in Example 1, except that no antistatic agent was added. The surface resistivity of the light diffusion plate obtained was 3×10¹⁷ Ω. indicating no antistatic property. Also, the brightness before and after the formation of the thin film was 4,000 cd/m², which was not changed, and the decreasing rate was 0%. However, the brightness after the accelerated light resistance test was 3,000 cd/m², and the decreasing rate was as large as 25%, indicating a poor light resistance, so that it was not suitable for use in a backlight unit for liquid crystal display devices.

### Comparative Example 2-3

A light diffusion plate was produced by applying (in a thickness of 8 μm) an antistatic spray (SB-8, available from Showa Co., Ltd.) to a thermoplastic resin sheet (2 mm in thickness) of a polycarbonate type resin obtained in the same manner as described in Example 1, except that no transfer film was used. The surface resistivity of the light diffusion plate obtained was 3×10⁹ Ω, indicating an excellent antistatic property. However, the surface resistivity after the accelerated light resistance test was 4×10¹⁷ Ω, indicating a poor light resistance. Also, the brightness after the application of the antistatic spray was 3,100 cd/m², whereas the brightness before the application of the antistatic spray was 4,000 cd/m², and the decreasing rate was as large as 23%, so that it was not suitable for use in a backlight unit for liquid crystal display devices.

### Comparative Example 2-4

A light diffusion plate was produced by applying an antistatic coating of the zinc oxide type (DC plate, available from Sekisui Chemical Co., Ltd.; thickness, 3 μm) to both sides of a thermoplastic resin sheet (2 mm in thickness) of a polycarbonate type resin obtained in the same manner as described in Example 1, except that no transfer film was used. The surface resistivity of the light diffusion plate obtained was 2×10⁶ Ω, indicating an excellent antistatic property. However, the brightness after the application of the antistatic coating was 2,800 cd/m², whereas the brightness before the application of the antistatic coating was 4,000 cd/m², and the decreasing rate was as large as 30%, so that it was not suitable for use in a backlight unit for liquid crystal display devices.

### Comparative Example 2-5

A light diffusion plate was produced by attaching a photocatalyst coated film with an adhesive layer (Laclean, available from Kimoto Co., Ltd.; thickness, 75 μm) to a thermoplastic resin sheet (2 mm in thickness) of a polycarbonate type resin obtained in the same manner as described in Example 1, except that no transfer film was used. The surface resistivity of the resultant light diffusion plate was 2×10⁹ Ω, indicating an excellent antistatic property. However, the brightness after the attachment of the photocatalyst coated film was 3,000 cd/m², whereas the brightness before the attachment of the photocatalyst coated film was 4,000 cd/m², and the decreasing rate was as large as 25%, so that it was not suitable for use in a backlight unit for liquid crystal display devices.

### INDUSTRIAL APPLICABILITY

In the present invention, the first invention makes a great contribution to wide fields using thermoplastic resin sheets because a thermoplastic resin sheet even having an uneven surface can be provided, by forming thereon a thin film having functionality with high adhesion while the thin film is allowed to follow the uneven surface thereof, with various kinds of functionalities, such as an antistatic property, a light resistance, a super water repellency, a super hydrophilicity, a defogging property, a low reflection property, and an anti-reflection property. Also, the second invention makes a great contribution to wide fields using liquid crystal display devices because the adhesion of dust in a light diffusion plate can be suppressed, and as a result, a reduction in the uniformity and brightness of light in liquid crystal display devices can be prevented, so that display images can be stabilized for a long period of time and their display quality can be improved.

The preset invention has been fully described by way of Examples, it is to be understood that various changes and modifications will be apparent to those skilled in the art. Therefore, unless such changes and modifications depart from the scope of the present invention defined below, they should be construed as being included therein. The scope of the present invention, therefore, should be determined by the following claims.

The Patent Application Publications cited above are incorporated herein by reference.

1. A functional thermoplastic resin sheet comprising a thin film of at least one layer formed on at least one side of a thermoplastic resin sheet by a transfer method, wherein at least one layer of the thin film has functionality.

2. The functional thermoplastic resin sheet according to claim 1, wherein at least one layer of the thin film contains an ultraviolet absorbing agent.

3. The functional thermoplastic resin sheet according to claim 1, wherein the resin forming at least one layer of the thin film has an ultraviolet absorbing property.

4. The functional thermoplastic resin sheet according to claim 1, wherein at least one layer of the thin film contains an antistatic agent.

5. The functional thermoplastic resin sheet according to claim 1, wherein at least one layer of the thin film contains a fluorescent whitener.

6. The functional thermoplastic resin sheet according to claim 1, wherein at least one layer of the thin film contains fine particles.

7. The functional thermoplastic resin sheet according to claim 1, wherein the thermoplastic resin sheet is a thermoplastic resin sheet having an uneven surface, and has a thin film of at least one layer formed on the uneven surface by a transfer method.

8. The functional thermoplastic resin sheet according to claim 7, wherein the thermoplastic resin forming the sheet is an amorphous resin.

9. A light diffusion plate for liquid crystal displays, wherein the functional thermoplastic resin sheet according to claim 1 is used for a backlight unit in a liquid crystal display.

10. The light diffusion plate for liquid crystal displays according to claim 9, wherein a decreasing rate of brightness after an accelerated test of light resistance is 20% or lower, and a surface resistivity value is 10¹⁴ Ω or lower after an accelerated test of light resistance.

11. A process for producing a functional thermoplastic resin sheet according to claim 7, comprising transferring, using a transfer film with a thin film of at least one layer formed on a surface of a base film, the thin film to an uneven surface of a thermoplastic resin sheet having the uneven surface, at which when the glass transition temperature of a thermoplastic resin sheet is denoted as Tg, a surface temperature of the thermoplastic resin sheet is in a range of not lower than (Tg−10° C.) and not higher than (Tg+70° C.), and a base film having a softening point lower than the surface temperature of the thermoplastic resin sheet is used.

12. A process for producing a light diffusion plate for liquid crystal displays according to claim 9, comprising extruding a thermoplastic resin sheet while transferring, using a transfer film with a thin film formed on a surface of a base film, the thin film of at least one layer on at least one side of the thermoplastic resin sheet.

13. The production process according to claim 12, wherein a heat-resistant temperature of the base film is 80° C. or higher.

14. The production process according to claim 12, wherein a thickness of the base film is not smaller than 10 μm and not greater than 100 μm.

15. The production process according to claim 12, wherein a peel strength of the base film after the thin film was transferred is not smaller than 0.02 N/cm and not greater than 1.0 N/cm.

16. A transfer film with a thin film formed on a surface of a base film, which transfer film uses at least one kind of film selected from low density polyethylene films, high density polyethylene films, linear low density polyethylene films, biaxially oriented polypropylene films (OPP films), and cast polypropylene films (CPP films) as the base film and has excellent transferability to an uneven surface.
